(19) United States
(12) Patent Application Publication
(10) Pub. No.: US 2008/0054773 A1
(43) Pub. Date: Mar. 6, 2008

(54) Dielectric barrier diescharge excimer light source

(75) Inventors: Mikhail I LOMAEV, Tomsk (RU); Andrey A. LISENKO, Tomsk (RU); Victor S. SKAKUN, Tomsk (RU); Dmitrii V. SHITZ, Tomsk (RU); Victor F. TARASENKO, Tomsk (RU); Yoshiie MATSUMOTO, Tokyo (JP)

Correspondence Address: VENABLE LLP, P.O. BOX 34385, WASHINGTON, DC, 20043-9998, US

(73) Assignees: Sen Engineering Co., Ltd., Tokyo (JP); High Current Electronics Institute, Tomks (RU)

(21) Appl. No.: 11/976,458

(22) Filed: Oct. 24, 2007

Related U.S. Application Data
(63) Continuation of application No. 10/594,386, filed on Sep. 27, 2006.

(30) Foreign Application Priority Data
Apr. 8, 2004 (JP) 2004-114304
Jul. 21, 2004 (RU) 2004-122213
Mar. 7, 2005 (JP) 2005-062950

(51) Int. Cl. H01J 1/02

(52) U.S. Cl. 313/110

(57) ABSTRACT

An anode electrode 10 is composed of a straight elongated cylindrical body, and the outer periphery of the cylindrical body is covered with a dielectric body 12. Further, a cathode portion 20 has a straight semicylindrical shape. A cathode 25 surrounds the anode, and the anode and cathode are disposed parallel to each other in the longitudinal direction. Further, the cathode comprises a cathode wire group 16. Both ends of the cathode wire group are fixed to both ends 20D in the longitudinal direction of the semicylindrical body constituting the cathode portion, so that a plurality of wires become parallel to each other. A reflective surface for reflecting irradiation in a vacuum ultraviolet region is formed on the surface 20S of the cathode portion at the side facing the anode.

### TECHNICAL FIELD

The present invention relates to a vacuum ultraviolet light source for emitting light with a wavelength in a vacuum ultraviolet (VUV) region with a high efficiency. In particular, the present invention relates to a highly efficient dielectric barrier discharge excimer light source that can be used as a vacuum ultraviolet light source (sometimes referred to hereinbelow as “VUV light source”) suitable for cleaning materials with ultraviolet light or reforming the material surface with ultraviolet light.

### BACKGROUND ART

Gas discharge light sources which use irradiation of B-X transition of an inert gas in a VUV region are well known as spontaneous emission light sources (spontaneous radiation lamps). Light sources which are representative of the gas discharge light sources of this type are VUV spontaneous emission light source using a dielectric barrier discharge that can obtain an intensive light emission generated by a transition of excimer molecules to an energy level of a ground state.

The dielectric barrier discharge is a discharge realized in discharge devices composed by disposing glass or ceramic, which is a dielectric, between electrodes. Disposing a dielectric body between electrodes makes it possible to prevent the occurrence of arc discharge between the electrodes and to realize light emission by excimer molecules with good stability.

The operation principle of light sources of this type which use a dielectric barrier discharge is based on light emission induced by the formation of the so-called excimer molecules in a discharge gas plasma (the molecules originate owing to a plasma chemical reaction induced by the dielectric barrier discharge proceeding in a gas) and spontaneous emission by those excimer molecules.

A specific feature of excimer molecules is that they have stable molecular bonds only in an excited state and in the ground state they exist in a separable state. This determines the generation of radiation in a variety of energy band zones, and B-X transition contributes most strongly to the light emission. In other words, excimer molecules are formed by a non-radiative transition and then light emission is induced by radiative transition of the excimer molecules to the energy level of the ground state. Due to the fact (observed fact) that the gas discharge radiation power of a maximum of 80% is concentrated for the B-X transition, the light emission based on the B-X transition can be expected to have a high efficiency.

The wavelength of the radiation based on the B-X transition corresponds to the VUV region which is strongly absorbed by most optical materials. For this reason, the VUV light source in accordance with the present invention does not use a pick-out window for picking out the VUV light. Thus, a sample (surface) that will be illuminated with light with a wavelength in the VUV region and an electrode unit of the light source are disposed in the same gas medium (Ar, Kr, Xe) which is used to obtain radiation at the same time. Furthermore, the VUV light source in accordance with the present invention can be also constructed by providing a pick-out window for picking out the VUV light, provided the window is fabricated from a material that does not absorb the radiation based on the B-X transition.

A light source based on a spontaneous emission of VUV light by hydrogen (dihydrogen) is known as a spontaneous emission light source that emits the aforementioned light with a wavelength in the VUV band (see Non-patent Reference 1). Furthermore, a radiation light source based on a mixed-gas mutual resonance transition employing hydrogen and an inert gas under a low pressure or those and a halogen is also known (see Non-patent Reference 2). Similarly, a high-pressure rare gas discharge tube for obtaining irradiation caused by the B-X transition of excimer molecules is also known (see Non-patent References 3, 4, and 5). The advantage of the light sources disclosed in the Non-patent References 3, 4, and 5 is that they have a high brightness.

Further, a variety of methods have been suggested for exciting high-pressure gas. Examples of such methods include a method using an electron beam (see Patent Reference 1), a method using a corona discharge (see Patent Reference 2 and Non-patent Reference 6), and a method using a barrier discharge (see Non-patent References 4, 5, 7, and 8). In case of electron beam excitation, a device is necessary for separating a chamber where an inert gas is sealed and the electrodes of the electron beam apparatus. As a result, the equipment has a complex structure.

A method using a corona discharge was studied with the object of realizing a simpler apparatus, but a corona discharge is difficult to stabilize. A power loss of 50% has to be allowed for the stabilization. Furthermore, when a plurality of point discharge chambers using a plurality of discharge locations are used, a power loss for resistance control increases accordingly. Moreover, there are also conditions for confining the excimer molecules inside the corona discharge region (see Patent Reference 2).

It has been initially indicated that a maximum irradiation efficiency of excimer molecules of about 60% is realized by one-barrier discharge induced by excitation of Xe atoms (see Non-patent Reference 7). This was later confirmed experimentally (see Non-patent Reference 8).

According to Non-patent Reference 7, the conditions necessary for emitting light from a Xe light source with a high efficiency include the excitation of most Xe atoms and the selection of an excitation mode allowing for the realization of a minimum energy loss of a parasitic oscillation process. In addition, it is necessary to use a pulse source with a short voltage rise time and to realize a homogeneous discharge. The light source described in Non-patent Reference 7 has a Xe gas sealed therein, comprises a metallic rod-like cathode, and is sealed with a fused quartz (Suprasil quartz-type: fused quartz marketed under a trade name Suprasil). The anode has a structure in which a mesh is disposed on the outer surface of the fused quartz tube.

Inside the discharge tube of this light source, the discharge current flows between a plurality of electrodes, cathodes and anodes are disposed alternately parallel to each other, and a radiation is generated form the discharge plasma of the gas. In case of light sources using Ar gas or Kr gas (the wavelength of emission caused by the B-X transition is 126 nm and 146 nm; respectively), the light with a wavelength of 160 nm or less is absorbed by the fused quartz. Therefore, the configuration of a light source in which the Ar gas or Kr gas and the electrodes are sealed with fused quartz is unsuitable.

The light sources disclosed in Non-patent References 5 and 9 do not have a window for picking out the radiation. Thus, they are not constructed as a light source in which the Ar gas or Kr gas and the electrodes are sealed with fused quartz. The discharge is initiated between the anode and cathode electrodes arranged in a row parallel to each other in the longitudinal direction and mutually connected and a dielectric tube surrounding the electrodes. The disadvantage of the light source of such a configuration with respect to the light source disclosed in Non-patent References 7 is that a voltage (insulation breakdown voltage) at which the discharge is initiated becomes higher as the pressure of the gas contributing to the light emission decreases.

[Non-patent Reference 1] A. N. Zaidel, E. Ya Schreider, VUV spectroscopy, Moscow “Nauka”, 1967.

[Non-patent Reference 2] L. P. Schischatskaya, S. A. Yakovlev, G. A. Volkova, VUV lamps with a large emitting surface, Optical Journal, Vol. 65, No. 12, pp. 93-95, 1998.

[Non-patent Reference 3] Y. Tanaka, Continuous emission spectra of rare gases in the vacuum ultraviolet region, J. Opt. Soc. Am. Vol. 45, No. 9, pp. 710-713, 1955.

[Non-patent Reference 4] G. A. Volkova, N. N. Kirillova, E. N. Pavlovskaya, I. V. Podmoschenskii, A. V. Yakovleva, VUV irradiation lamp. Bul. of Inventions, 1982, No. 41 p. 179.

[Non-patent Reference 5] U. Kogelschatz, Silent-discharge driven excimer UV sources and their applications, Appl. Surf Sci, Vol. 54, pp. 410-423, 1992.

[Non-patent Reference 6] M. Salvermoser, D. E. Murnick, Efficient, stable, corona discharge 172 nm xenon excimer light source, J. Appl. Phys. Vol. 94, No. 6, pp. 3722-3731, 2003.

[Non-patent Reference 7] F. Vollkommer, L. Hitzschke, Dielectric Barrier Discharge, The 8^{th} International. Symposium on Science and Technology of LIGHT SOURCES LS-8, Greifswald, Germany, pp. 51-60, 1998.

[Non-patent Reference 8] R. P. Mildren, R1 J. Carman, Enhanced performance of a dielectric barrier discharge lamp using short-pulsed excitation, J. Phys. D: Appl. Phys. Vol. 34, pp. L1-L6, 2001.

[Non-patent Reference 9] H. Esrom and U. Kogelschatz, Appl. Surf. Sci. Vol. 54, p. 440, 1992.

[Patent Reference 1] U.S. Pat. No. 6,052,401

[Patent Reference 2] U.S. Pat. No. 6,400,089

### DISCLOSURE OF THE INVENTION

### Problems to be Solved by the Invention

It is an object of the present invention to provide a VUV light source for realizing high-efficiency light emission and to provide a spontaneous emission light source in which the absorption of radiation by the walls of the discharge tube is prevented and high-brightness light with a wavelength in the VUV region can be obtained. Yet another object is to provide the structure of cathode and anode which allows for efficient illumination of the object (illumination object) which is to be illuminated with the light with a wavelength in the VUV region.

### Means fore Solving the Problems

The first dielectric barrier discharge excimer light source in accordance with the present invention comprises an anode having a dielectric body and an anode electrode covered with the dielectric body and composed of a straight elongated hollow cylindrical body and an elongated cathode surrounding the anode. The cathode comprises a straight semicylindrical body and a cathode wire group composed of a plurality of wires fixed parallel to each other to the semicylindrical body. The anode and the cathode are disposed parallel to each other in the longitudinal direction. A reflective surface for reflecting the radiation in a vacuum ultraviolet spectral region is formed on the surface of the cathode at the side facing the anode.

The second dielectric barrier discharge excimer light source in accordance with the present invention comprises an anode having a dielectric body and an anode electrode covered with the dielectric body and composed of a straight elongated hollow cylindrical body and an elongated cathode surrounding the anode. The cathode comprises a straight semitubular rectangular body composed of three surfaces and having a U-shaped cross section perpendicular to the longitudinal direction and a cathode wire group composed of a plurality of wires fixed parallel to each other to the semitubular body. The anode and the cathode are disposed parallel to each other in the longitudinal direction. Further, a reflective surface for reflecting the radiation in a vacuum ultraviolet spectral region is formed on the surface of the cathode at the side facing the anode.

The third dielectric barrier discharge excimer light source in accordance with the present invention comprises an anode having a dielectric body and an anode electrode covered with the dielectric body and composed of an elongated hollow tubular body composed of four surfaces and having a rectangular cross section perpendicular to the longitudinal direction and a cathode comprising a straight semitubular rectangular body composed of three surfaces and having a U-shaped cross section perpendicular to the longitudinal direction and a cathode wire group composed of a plurality of wires fixed parallel to each other to the semitubular body. The cathode is disposed so as to surround the anode, and the anode and the cathode are disposed parallel to each other in the longitudinal direction. Further, a reflective surface for reflecting the radiation in a vacuum ultraviolet spectral region is formed on the surface of the cathode at the side facing the anode.

The fourth dielectric barrier discharge excimer light source in accordance with the present invention comprises an anode group composed of a plurality of anodes having a dielectric body and an anode electrode covered with the dielectric body and composed of a straight elongated hollow cylindrical body, the anodes being disposed in a row so as to be parallel to the straight elongated cylindrical body, and a cathode comprising a cathode wire group composed of a plurality of wires fixed parallel to each other to a straight semitubular body composed of three surfaces and having a U-shaped cross section perpendicular to the longitudinal direction. The cathode is disposed so as to surround the anode, and the anode and the cathode are disposed parallel to each other in the longitudinal direction. Further a reflective surface for reflecting the radiation in a vacuum ultraviolet spectral region is formed on the surface of the cathode at the side facing the anode.

The fifth dielectric barrier discharge excimer light source in accordance with the present invention comprises an anode group composed of a plurality of anodes having a dielectric body and an anode electrode covered with the dielectric body and composed of an elongated hollow tubular body composed of four surfaces and having a rectangular cross section perpendicular to the longitudinal direction, the anodes being disposed in a row so as to be parallel to the straight elongated tubular body, and an elongated cathode surrounding the anode and comprising a cathode wire group composed of a plurality of wires fixed parallel to each other to a straight semitubular body composed of three surfaces and having a U-shaped cross section perpendicular to the longitudinal direction. The anode and the cathode are disposed parallel to each other in the longitudinal direction, and a reflective surface for reflecting the radiation in a vacuum ultraviolet spectral region is formed on the surface of the cathode at the side facing the anode.

The sixth dielectric barrier discharge excimer light source in accordance with the present invention comprises discharge electrode units each comprising an anode having a dielectric body and an anode electrode covered with the dielectric body and composed of a straight elongated hollow cylindrical body and an elongated cathode surrounding the anode, the cathode comprising a straight semicylindrical body and a cathode wire group composed of a plurality of wires fixed parallel to each other to the semicylindrical body. The discharge electrode units are disposed in a row parallel to each other in the longitudinal direction. A reflective surface for reflecting the radiation in a vacuum ultraviolet spectral region is formed on the surface of the cathode at the side facing the anode.

The seventh dielectric barrier discharge excimer light source in accordance with the present invention comprises discharge electrode units each comprising an anode having a dielectric body and an anode electrode covered with the dielectric body and composed of a straight elongated hollow cylindrical body and an elongated cathode surrounding the anode, the cathode comprising a straight semitubular body composed of three surfaces and having a U-shaped cross section perpendicular to the longitudinal direction and a cathode wire group composed of a plurality of wires fixed parallel to each other to the semitubular body. The discharge electrode units are disposed in a row parallel to each other in the longitudinal direction. A reflective surface for reflecting the radiation in a vacuum ultraviolet spectral region is formed on the surface of the cathode at the side facing the anode.

The eighth dielectric barrier discharge excimer light source in accordance with the present invention comprises discharge electrode units each comprising an anode having a dielectric body and an anode electrode covered with the dielectric body and composed of an elongated hollow tubular body composed of four surfaces and having a rectangular cross section perpendicular to the longitudinal direction and an elongated cathode surrounding the anode, the cathode comprising a straight semitubular body composed of three surfaces and having a U-shaped cross section perpendicular to the longitudinal direction and a cathode wire group composed of a plurality of wires fixed parallel to each other to the semitubular body. The discharge electrode units are disposed in a row parallel to each other in the longitudinal direction. A reflective surface for reflecting the radiation in a vacuum ultraviolet spectral region is formed on the surface of the cathode at the side facing the anode.

A specific feature of the ninth dielectric barrier discharge excimer light source in accordance with the present invention is that the cathode is provided in a configuration such that a plurality of straight rod-like auxiliary conductors are disposed in the same plane in a row parallel to the longitudinal direction of the semitubular body. Thus, straight rod-like auxiliary conductors which have the same potential as the cathode are disposed parallel to the longitudinal direction of the semitubular body between the anode group and the cathode wire group.

A specific feature of the tenth dielectric barrier discharge excimer light source in accordance with the present invention is that the anode electrode has a semicylindrical shape, the convex surface of the semicylindrical shape is disposed in the direction where the cathode wire group is disposed, and the ends along the longitudinal direction of the semicylindrical shape have the shape rounded toward the inside of the semicylindrical shape.

A specific feature of the eleventh dielectric barrier discharge excimer light source in accordance with the present invention is that the anode electrode has a semitubular shape, the bottom surface of the semitubular shape is disposed in the direction where the cathode wire group is disposed, and the ends along the longitudinal direction of the semitubular shape have the shape rounded toward the inside of the rectangular shape.

The twelfth dielectric barrier discharge excimer light source comprises an anode having a dielectric body and an anode electrode covered with the dielectric body and composed of a straight elongated hollow cylindrical body and a metallic cathode wire in the form of a spirally shaped body. The cathode wire is disposed so as to surround said anode, the central axis of the spirally shaped body coinciding with the central axis of the cylindrical body.

The thirteenth dielectric barrier discharge excimer light source comprises an anode having a dielectric body and an anode electrode covered with the dielectric body and composed of a straight elongated hollow cylindrical body and a metallic cathode wire in the form of a spirally shaped body. The cathode wire is disposed so as to surround said anode, the central axis of the spirally shaped body coinciding with the central axis of the cylindrical body. The anode and the cathode wire are disposed inside a reflector. The reflector is a straight elongated semitubular body, and the longitudinal direction of said semicylindrical body, the central axis of the cylindrical body, and the central axis of the spirally shaped body are disposed parallel to each other.

The fourteenth dielectric barrier discharge excimer light source comprises a coaxial discharge electrode unit comprising an anode having a dielectric body and an anode electrode covered with said dielectric body and composed of a straight elongated hollow cylindrical body and a metallic cathode wire in the form of a spirally shaped body, and constructed such that the cathode wire is disposed so as to surround the anode, the central axis of the spirally shaped body coinciding with the central axis of said cylindrical body. A plurality of coaxial discharge electrode units are arranged in a row so that the central axes thereof are parallel to each other and are disposed inside a single reflector. The reflector is a semitubular rectangular body composed of three surfaces with a U-shaped cross section perpendicular to the longitudinal direction and the longitudinal direction and the central axis of the cylindrical body are disposed parallel to each other.

A common feature of the fifteenth dielectric barrier discharge excimer light source in accordance with the present invention and the above-described twelfth to fourteenth dielectric barrier discharge excimer light sources is that they comprise a coaxial discharge electrode unit comprising an anode having a dielectric body and an anode electrode covered with the dielectric body and composed of a straight elongated hollow cylindrical body and a metallic cathode wire in the form of a spirally shaped body, and constructed such that the cathode wire is disposed so as to surround the anode, the central axis of the spirally shaped body coinciding with the central axis of the cylindrical body. The difference therebetween is in that in the fifteenth dielectric barrier discharge excimer light source, the anode has a semicylindrical shape and the ends along the longitudinal direction of the semicylindrical shape have the shape rounded toward the inside of the semicylindrical shape.

The sixteenth dielectric barrier discharge excimer light source in accordance with the present invention comprises an anode having a dielectric body and an anode electrode covered with said dielectric body and composed of a straight elongated hollow cylindrical body and a metallic cathode wire in the form of a spirally shaped body, and constructed such that the cathode wire is disposed so as to surround the anode, with the central axis of the spirally shaped body coinciding with the central axis of said cylindrical body. The cathode wire and the anode are disposed inside a tube fabricated from a dielectric material which is transparent with respect to the wavelength of the emitted light, and the cathode wire and the anode are sealed with said tube fabricated from a dielectric material which is transparent with respect to the wavelength of the emitted light.

The above-described first to sixteenth dielectric barrier discharge excimer light sources of the present invention are preferably configured so that the distance between the anode and cathode is 0-2 mm.

The above-described first to sixteenth dielectric barrier discharge excimer light sources are preferably constructed so that a liquid or gas for cooling can circulate inside the casing of the anode.

### EFFECT OF THE INVENTION

The first to third dielectric barrier discharge excimer light sources in accordance with the present invention have a structure in which the cathode wire group is attached to the cathode. Therefore, the electric field intensity in the region close to the wires constituting the wire group can be increased and the generation of dielectric barrier discharge is facilitated. Furthermore, a stable discharge can be realized in the discharge gas under a high pressure and the light emission efficiency with respect to the electric power inputted in the excimer light source can be increased. Thus, a spontaneous emission light source for emitting high-brightness light with a wavelength in a vacuum ultraviolet region can be provided.

Further, because a reflective surface for reflecting the radiation in a vacuum ultraviolet spectral region is formed on the surface of the cathode at the side facing the anode, the illumination object which is to be illuminated with light with a wavelength in the vacuum ultraviolet region can be illuminated with good efficiency.

Further, the first to third dielectric barrier discharge excimer light sources in accordance with the present invention are constructed so that no window is disposed between the region in which the above-mentioned vacuum ultraviolet radiation light is generated and the region where the illumination object which is to be illuminated with the vacuum ultraviolet radiation light is disposed. As a result, the vacuum ultraviolet radiation light is not absorbed by the material constituting the window. Therefore, the illumination object can be illuminated with the vacuum ultraviolet radiation light with the intensity increased by the fraction which is not absorbed by the window.

Further, the fourth to eighth dielectric barrier discharge excimer light sources in accordance with the present invention comprises an anode group instead of a single anode. As a result, the total surface area of the dielectric body covering the anode electrode can be expanded by increasing the number of anode units. Therefore, the surface area of possible illumination with respect to the illumination object can be expanded.

In the ninth dielectric barrier discharge excimer light source, the cathode is provided in a shape such that a plurality of rod-like auxiliary conductors which are parallel to the longitudinal direction of the straight semitubular body are disposed in a row in the same plane. Therefore, the inductance induced in the lead-in conductive wire and the wires constituting the wire group can be reduced. As a result, the efficiency of electric power supplied to the dielectric barrier discharge excimer light source can be increased and a vacuum ultraviolet light source realizing a high-efficiency light emission can be obtained.

In the tenth or eleventh dielectric barrier discharge excimer light source, the anode electrode which is to be set has a shape such that the end portions along the longitudinal direction of the semicylindrical shape or the end portions along the longitudinal direction of the semitubular shape have the shape rounded toward the inside of the semicylindrical shape or toward the inside of the rectangle. As a result, it is possible to fabricate a light source in which the electrostatic capacitance between the electrodes can be reduced, the region where plasma is formed can be established exclusively in the portion of the semicylindrical convex surface or at the side of the bottom surface of the semitubular portion, and the illumination object can be illuminated with the vacuum ultraviolet light radiated with better efficiency.

The twelfth dielectric barrier discharge excimer light source in accordance with the present invention comprises an anode electrode covered with a dielectric body and composed of a straight elongated cylindrical body and a metallic cathode wire in the form of a spirally shaped body wherein the cathode wire is disposed so as to surround the anode, the central axis of said cathode wire in the form of a spirally shaped body coinciding with the central axis of said cylindrical body. As a result, the volume of the region occupied by the discharge plasma can be increased and the intensity of the vacuum ultraviolet light which is emitted can be accordingly increased.

The thirteenth dielectric barrier discharge excimer light source in accordance with the present invention comprises a reflector. Therefore, the vacuum ultraviolet light which is emitted by the discharge can be arranged and outputted as an almost parallel beam. As a result, the illumination object can be illuminated with the vacuum ultraviolet light with a better efficiency.

The fourteenth dielectric barrier discharge excimer light source in accordance with the present invention has a configuration comprising a plurality of coaxial discharge electrode units. Therefore, the total surface area of the dielectric body covering the anode can be expanded by increasing the number of anode units. As a result, the surface area of possible illumination with respect to the illumination object can be expanded.

The fifteenth dielectric barrier discharge excimer light source in accordance with the present invention has a configuration comprising an electrode having a structure identical to that of the anode electrode and a dielectric body covering the anode electrode of the tenth dielectric barrier discharge excimer light source and a metallic cathode wire in the form of a spirally shaped body of the twelfth dielectric barrier discharge excimer light source. Therefore, similarly to the eleventh or twelfth dielectric barrier discharge excimer light source in accordance with the present invention, it is possible to obtain a light source in which the electrostatic capacitance between the electrodes can be reduced, the region where plasma is formed can be established with good stability and exclusively in the portion of the semicylindrical convex surface or at the side of the bottom surface of the semitubular portion, and the illumination object can be illuminated with the vacuum ultraviolet light radiated with better efficiency.

Further, if the first to sixteenth dielectric barrier discharge excimer light sources of the present invention are configured so that the distance between the anode and cathode is as small as 0-2 mm, it is possible to set a low voltage of the high-voltage pulsed power source for supplying electric power to those dielectric barrier discharge excimer light sources. As a result, the voltage required for the drive power source can be low and an accordingly high-voltage pulsed power source is easy to produce. Furthermore, with the configuration in which the distance between the anode and cathode is as small as 0-2 mm, plasma can be localized in the vicinity of the dielectric surface and the decrease in the light emission efficiency caused by the increase in plasma temperature can be prevented most efficiently.

### BRIEF DESCRIPTION OF THE DRAWINGS

FIG. 1 is a drawing for explaining the structure of the first dielectric barrier discharge excimer light source (first of two).

FIG. 2 is a drawing for explaining the structure of the first dielectric barrier discharge excimer light source (second of two).

FIG. 3 is a drawing for explaining the structure of the second dielectric barrier discharge excimer light source.

FIG. 4 is a drawing for explaining the structure of the third dielectric barrier discharge excimer light source.

FIG. 5 is a drawing for explaining the structure of the fourth dielectric barrier discharge excimer light source.

FIG. 6 is a drawing for explaining the structure of the fifth dielectric barrier discharge excimer light source.

FIG. 7 is a drawing for explaining the structure of the sixth dielectric barrier discharge excimer light source.

FIG. 8 is a drawing for explaining the structure of the seventh dielectric barrier discharge excimer light source.

FIG. 9 is a drawing for explaining the structure of the eighth dielectric barrier discharge excimer light source.

FIG. 10 is a drawing for explaining the structure of the ninth dielectric barrier discharge excimer light source.

FIG. 11 is a schematic cross-sectional structural view of the anode and dielectric cover portion of the tenth and eleventh dielectric barrier discharge excimer light source in accordance with the present invention.

FIG. 12 is a drawing for explaining the structure of the twelfth dielectric barrier discharge excimer light source.

FIG. 13 is a drawing for explaining the structure of the thirteen dielectric barrier discharge excimer light source.

FIG. 14 is a drawing for explaining the structure of the fourteen dielectric barrier discharge excimer light source.

FIG. 15 is a drawing for explaining the structure of the fifteen dielectric barrier discharge excimer light source.

FIG. 16 is a drawing for explaining the structure of the sixteen dielectric barrier discharge excimer light source.

FIG. 17 is employed for explaining the distance between the anode and cathode.

FIG. 18 is an equivalent circuit comprising a high-output pulsed power source and a dielectric barrier discharge excimer light source.

FIG. 19 illustrates the dependence of the breakdown voltage on the distance between the anode and cathode.

### EXPLANATION OF LETTERS OR NUMERALS

10, 40, 60, 66, 110, 140, 150, 190, 310: anode electrode
12, 42, 62, 68, 112, 142, 152, 192, 312: dielectric body
15, 45, 115, 145, 155, 195, 315: anode
14, 22: lead-in wire
16, 316: cathode wire group
18, 300, 330: high-voltage pulse power source
20, 30, 50: cathode portion
24: illumination object
25, 35, 55: cathode
64, 70: anode group
80, 82, 84, 86, 88, 90, 92, 94, 96: discharge electrode unit
102, 104: rod-like conductor
160, 194: cathode wire
170: reflector
182, 184, 186: coaxial discharge electrode unit
200: tube fabricated from a dielectric material.
320: dielectric barrier discharge excimer light source
322: capacitor with an electrostatic capacitance C_{d}
324: variable resistor with a resistance value R_{gap}
326: capacitor 326 with an electrostatic capacitance C_{g}

### BEST MODE FOR CARRYING OUT THE INVENTION

The modes of implementing the present invention will be described hereinbelow with reference to the drawings. The figures merely schematically illustrate the shape, size and mutual arrangement of the components to the extent allowing for the understanding of the present invention, and the present invention is not limited to the examples illustrated by the drawings. Furthermore, in the explanation below, specific materials and conditions are used, but those materials and conditions merely represent one of the preferred examples and are, therefore, not limiting. Further, in the drawings, the identical structural elements are denoted by the identical reference symbols, and redundant explanation of function thereof will be sometimes omitted.

### Embodiment 1

The structure of the first dielectric barrier discharge excimer light source in accordance with the present invention and the operation principle thereof will be described hereinbelow with reference to FIG. 1 and FIG. 2. FIG. 1 is a schematic transverse sectional view obtained by cutting the first dielectric barrier discharge excimer light source in accordance with the present invention along the direction perpendicular to the longitudinal direction of the anode. FIG. 2 is a schematic vertical sectional view obtained by cutting the dielectric barrier discharge excimer light source in accordance with the present invention along the direction parallel to the longitudinal direction of the anode.

An anode electrode 10 is composed of a straight elongated cylindrical body and has a structure in which the outer periphery of the cylindrical body is covered with a dielectric body 12. An anode 15 comprises the anode electrode 10 and the dielectric body 12. In the explanation below, the structural body composed of the anode electrode and dielectric body will be referred to as an anode structural body.

Further, a cathode 25 comprises a cathode portion 20 of a straight semicylindrical shape and a cathode wire group 16. Further, the cathode portion 20 has a straight semicylindrical shape, the cathode 25 surrounds the anode electrode 10, and the anode electrode 10 and cathode portion 20 are arranged parallel to each other in the longitudinal direction. In the cathode wire group 16, both ends of the wires are fixed at both ends 20D of the semicylindrical body constituting the cathode portion 20, those ends extending along the longitudinal direction, so that a plurality of wires (wire stubs) are arranged parallel to each other. Further, a reflective surface for reflecting the VUV radiation is formed at a surface 20S of the cathode portion 20 at the side opposite the anode electrode 10. In the explanation below, the structural body composed of the cathode portion and cathode wire group will be referred to as a cathode structural body.

The anode electrode 10 is connected to a high-voltage pulse power source 18 with an lead-in conductive wire 14, and the cathode 25 is grounded with an lead-in conductive wire 22. Further, the anode electrode 10, cathode 25, and an illumination object 24 are disposed in a chamber (not shown in the figure) filled with an inert gas (discharge gas) such as Ar, Kr, and Xe. A pulse voltage is applied from the high-voltage pulse power source 18 so that the potential of the anode electrode 10 becomes positive with respect to the cathode 25. Thus, a high-voltage pulse of positive polarity is applied to the anode electrode 10.

If a high pulse voltage is applied between the anode electrode 10 and cathode 25, a dielectric barrier discharge is induced between the two electrodes and a discharge plasma is generated. This discharge plasma excites the atoms of the discharge gas, instantaneously forming excimer molecules. The excimer molecules generate irradiation (light emission in a VUV band) when they make a transition (B-X transition) to a ground state which is the original state of atoms. Thus, light emission caused by spontaneous emission and a spontaneous emission light source is realized.

Further, the first dielectric barrier discharge excimer light source of the present invention shown in FIG. 1 also includes the case where the anode 15 and cathode wire group 16 are disposed in contact with each other. In this case, the light source can be operated in a state with the lowest voltage of the high-voltage pulsed power source 18 for supplying electric power to the light source. As a result, the supplied voltage required for the light source can be set at a low level. Therefore, the output voltage required for the drive power source of the light source may be low and the design of the power source is accordingly facilitated.

In the explanation hereinbelow, the shapes of the anode structure and cathode structure differ between the embodiments, but the operation principle according to which if a high-voltage pulse voltage is applied between those electrodes, a dielectric barrier discharge is induced between the electrodes that are arranged in contact or separately, excimer molecules are formed instantaneously, and light is emitted by a spontaneous emission of the excimer molecules is common for the second to sixteenth dielectric barrier discharge excimer light sources of the present invention.

This radiation light caused by irradiation will be sometimes referred to hereinbelow as VUV radiation light. Further, the irradiation generated when the excimer molecules make a transition to the ground state which is the original state of atoms will be sometimes referred to as excimer light emission. The wavelength of this irradiation is determined by the type of the discharge gas. Under the effect of this irradiation, light emission is induced in the space between the dielectric body 12 covering the anode electrode 10 and the cathode 25, that is, at the periphery of the dielectric body 12. Because the anode electrode 10 is covered with the dielectric body 12, the transformation of the discharge that was once generated in an arc discharge can be maintained and the excimer light emission can be maintained.

A first specific feature of the first dielectric barrier discharge excimer light source in accordance with the present invention is that a window made from a material absorbing the VUV radiation light is not disposed to partition a region in which the above-mentioned VUV radiation light is generated and the region where the illumination object 24 which is to be illuminated with the VUV radiation light is disposed. As a result, because the VUV radiation light is not absorbed by the material constituting the window, the illumination object 24 can be illuminated with the VUV radiation light with good efficiency.

In the dielectric barrier discharge excimer light source, the realization of a continuous discharge is an ideal way to obtain continuous light emission. However, in the usual arc discharge, the discharge current density is low. Therefore, excimer molecules that have a life of merely about several nanoseconds cannot be generated with a high density and practically no excimer light emission can be obtained. Accordingly, it was decided to ensure a high discharge current density, while generating a pseudo-continuous discharge, by employing an electrode having a structure in which the anode electrode 10 is covered with the dielectric body 12 an inducing a dielectric barrier discharge.

The cathode wire group 16 attached to the cathode 20 is composed of a plurality of fine wires with a small diameter. Therefore, the electric field intensity in the region close to the wires can be increased. As a result, the dielectric barrier discharge can be easily generated and a stable discharge in the high-pressure discharge gas can realized. Because it is possible to realize a uniform stable discharge in the high-pressure discharge gas, a high density of excimer molecules can be maintained and the light emission efficiency related to the electric power supplied to the excimer light source can be increased. Thus, a spontaneous emission light source capable of generating high-brightness light with a wavelength in a VUV region can be provided.

As shown in FIG. 1, the reflective surface 20S for reflecting the VUV radiation light, that is, irradiation in a VUV spectral region, is formed on the surface of the cathode portion 20 at the side opposite the anode electrode 10 in order to illuminate the illumination object 24 with the illumination light (light within the VUV spectral region) with good efficiency. As a result, the object of illumination with light with a wavelength in the VUV region (illumination object) can be effectively illuminated. The reflective surface 20S can be formed by forming the cathode portion, for example, of aluminum which is a material capable of reflecting irradiation in the VUV spectral region and then subjecting the surface to mirror finish polishing. In the below-described embodiments, features relating to the reflective surface for reflecting the VUV radiation light, such as a method for the formation thereof, are common with those of the first embodiment, and the explanation thereof will be omitted.

On the other hand, the cathode wire group 16 and reflective surface 20S, in addition to maintaining a uniform intensity of electric field between them and the anode electrode 10, also play a role of mechanically protecting the anode electrode 10.

In the explanation of the second and subsequent embodiments presented hereinbelow, a feature of connecting the anode to a high-voltage pulse power source with a lead-in conductive wire and grounding the cathode with an lead-in conductive wire and a feature of disposing the anode, cathode, and illumination object in a chamber filled with a discharge gas are common and the explanation thereof is therefore omitted. Further, with the exception of Embodiment 16, no window is disposed for partitioning the above-described region where the vacuum ultraviolet radiation light is generated and the region where the illumination object 24 which is to be illuminated with the vacuum ultraviolet radiation light is disposed.

Further, a feature of applying a pulsed voltage from a high-voltage pulse power source so that the anode potential becomes positive with respect to the cathode is also common and the explanation of this feature is therefore omitted.

### Embodiment 2

FIG. 3 illustrates a structure of the second dielectric barrier discharge excimer light source in accordance with the present invention. FIG. 3 is a schematic transverse cross-sectional view of the second dielectric barrier discharge excimer light source in accordance with the present invention, this view being taken within a plane perpendicular to the longitudinal direction of the anode. Further, the schematic vertical cross-sectional view in the plane parallel to the longitudinal direction of the anode is similar to that shown in FIG. 2 and is therefore omitted. Furthermore, as a rule, in the explanation hereinbelow, only the transverse cross-sectional view of the light source is shown, and the vertical cross-sectional view similar to that shown in FIG. 2 is omitted unless considered especially necessary.

A feature of the second dielectric barrier discharge excimer light source comprising an anode electrode 10 composed of a straight long hollow cylindrical body covered with the dielectric body 12 and a long cathode portion 30 surrounding the anode electrode 10 is the same as in the above-described first dielectric barrier discharge excimer light source. However, the shape of the cathode portion 30 is different. The cathode portion 30 is a straight semitubular body composed of three surfaces (30S-1, 30S-2 and 30S-3) and having a U-shaped cross section perpendicular to the longitudinal direction. The cathode portion 30 surrounds the anode electrode 10, and the anode electrode 10 and cathode portion 30 are disposed parallel to each other in the longitudinal direction.

Further, the cathode portion 30 has a cathode wire group 16 composed of a plurality of wires fixed parallel to each other to the semitubular body. Therefore, the anode and cathode are disposed parallel to each other in the longitudinal direction. Furthermore, in the cathode wire group 16, both ends of the wires are fixed at both ends 30D of the semitubular body constituting the cathode portion 30, those ends extending in the longitudinal direction, so that a plurality of wires are arranged parallel to each other. Further, a reflective surface for reflecting the VUV radiation is formed at surfaces 30S-1, 30S-2, and 30S-3 of the cathode portion 30 at the side opposite the anode electrode 10.

### Embodiment 3

FIG. 4 illustrates a structure of the third dielectric barrier discharge excimer light source in accordance with the present invention. FIG. 4 is a schematic transverse cross-sectional view of the third dielectric barrier discharge excimer light source in accordance with the present invention, which is perpendicular to the longitudinal direction of the anode. Further, the schematic vertical cross-sectional view in the plane parallel to the longitudinal direction of the anode is similar to that shown in FIG. 2 and is therefore omitted.

A feature of the third dielectric barrier discharge excimer light source comprising an anode electrode 40 composed of a straight long hollow cylindrical body covered with a dielectric body and a long cathode portion 30 surrounding the anode electrode 40 is the same as in the above-described first dielectric barrier discharge excimer light source. However, the shapes of the anode electrode 40 and the cathode portion 30 are different. The anode electrode 40 is a tubular body composed of four surfaces (40S-1, 40S-2, 40S-3 and 40S-4) and covered by a dielectric body 42. The transverse cross section of the tubular body which is perpendicular to the straight longitudinal direction has a rectangular frame-like shape. On the other hand, the cathode portion 30 is a straight semitubular body composed of three surfaces (30S-1, 30S-2, and 30S-3) and having a U-shaped cross section perpendicular to the longitudinal direction. Further, a cathode 35 has the cathode portion 30 and a cathode wire group 16 composed of a plurality of wires fixed parallel to each other to the aforementioned semitubular body. The cathode 35 surrounds the anode electrode 40, and the anode electrode 40 and cathode portion 30 are disposed parallel to each other in the longitudinal direction.

### Embodiment 4

FIG. 5 illustrates a structure of the fourth dielectric barrier discharge excimer light source in accordance with the present invention. The fourth dielectric barrier discharge excimer light source in accordance with the present invention differs from the above-described first to third embodiments in that an anode group is provided instead of a single anode, this anode group being constituted by a plurality of anodes composed of straight elongated cylindrical bodies covered with dielectric bodies, wherein the anodes are disposed in a row so as to be parallel to the straight elongated body.

In this structural example, there are provided first, second and third anodes. The first anode 64a has an anode electrode 60a composed of a straight elongated cylindrical body and a dielectric body 62a covering the outer periphery of the anode electrode 60a. The second anode 64b has an anode electrode 60b composed of a straight elongated cylindrical body and a dielectric body 62b covering the outer periphery of the anode electrode 60b. The third anode 64c has an anode electrode 60c composed of a straight elongated cylindrical body and a dielectric body 62c covering the outer periphery of the anode electrode 60c. Those three anodes 64a, 64b, and 64c are disposed in a row (a row of three in this embodiment) inside a straight long semitubular body 50 along the longitudinal direction of the semitubular body 50. FIG. 5 illustrates a case with three anodes, but the number of anodes is not limited to three, and two or more than three anodes may be arranged.

The cathode 55 has a straight semitubular body 50 composed of three surfaces (50S-1, 50S-2, and 50S-3) and having a U-shaped cross section perpendicular to the longitudinal direction and a cathode wire group 16 composed of a plurality of wires fixed parallel to each other to this semitubular body 50. The cathode 55 is disposed in a position such as to surround the anode group 64. Further, a reflective surface for reflecting the VUV radiation is formed at surfaces (50S-1, 50S-2, and 50S-3) of the cathode at the side opposite the anode group 64.

### Embodiment 5

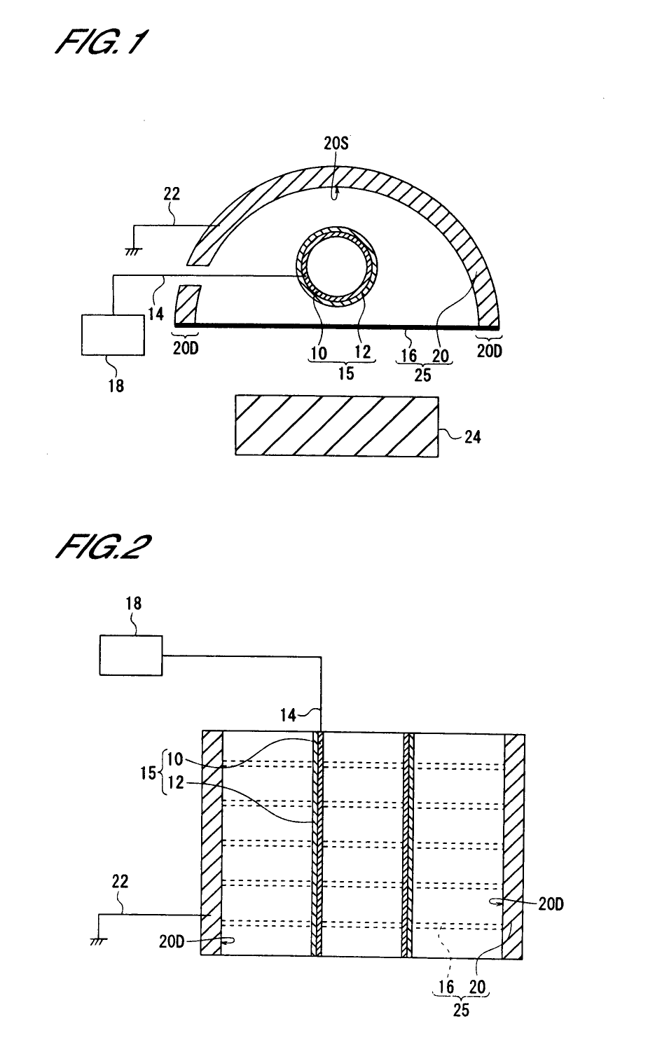

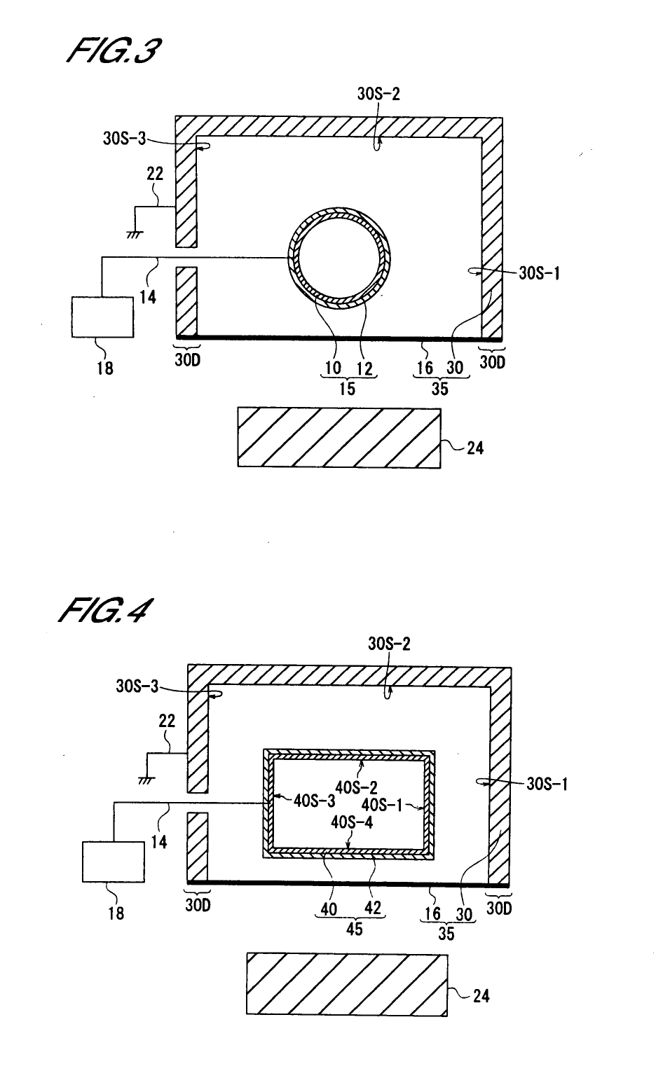

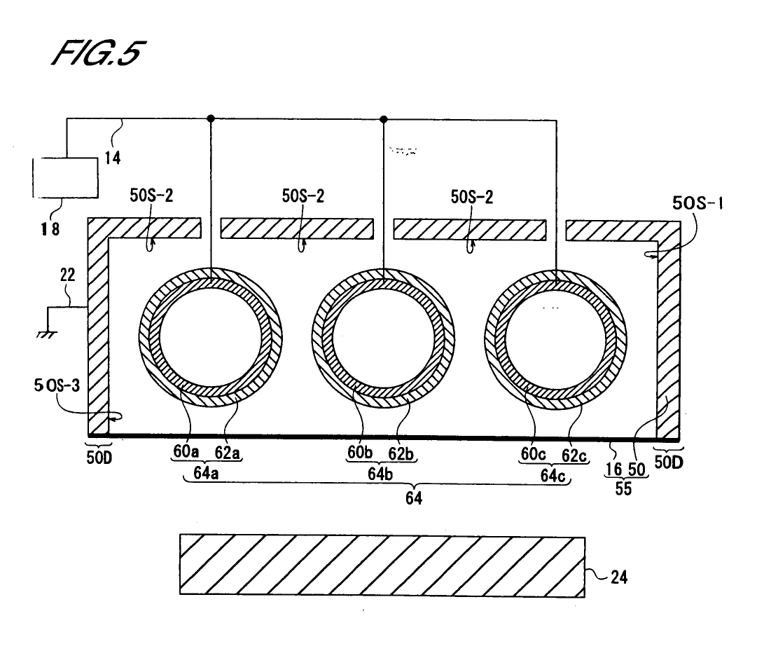

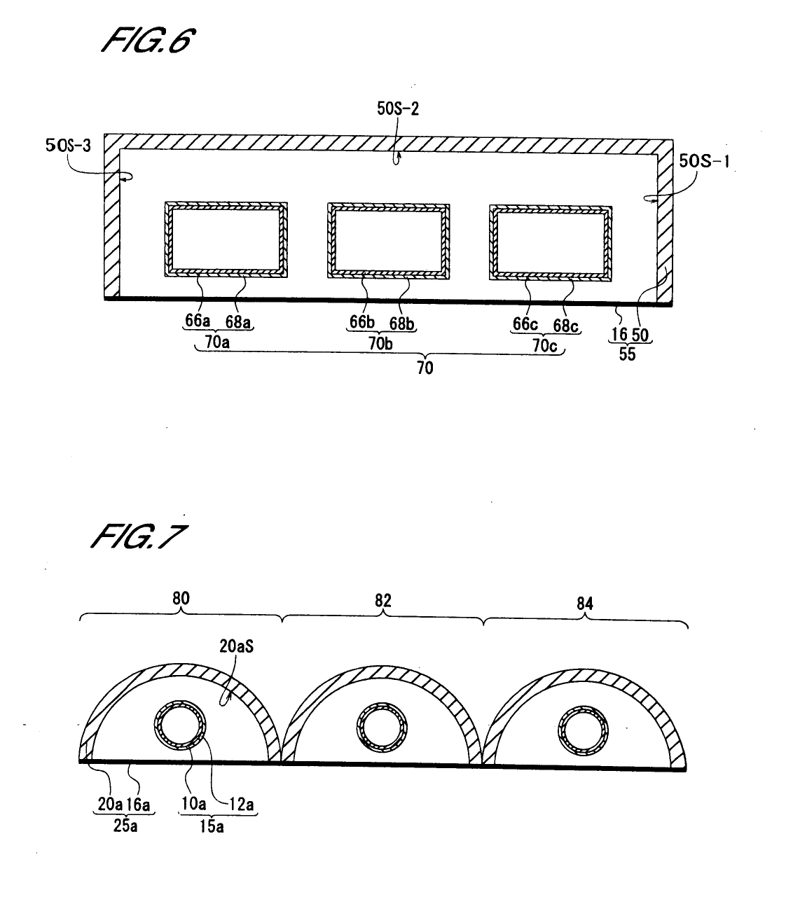

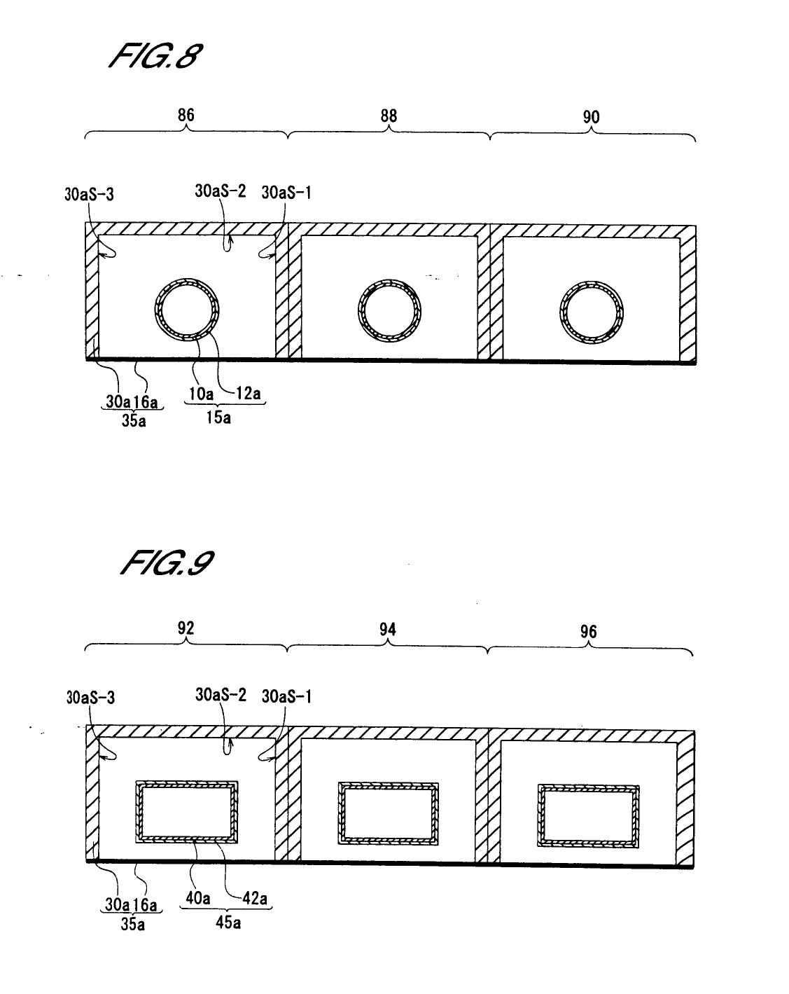

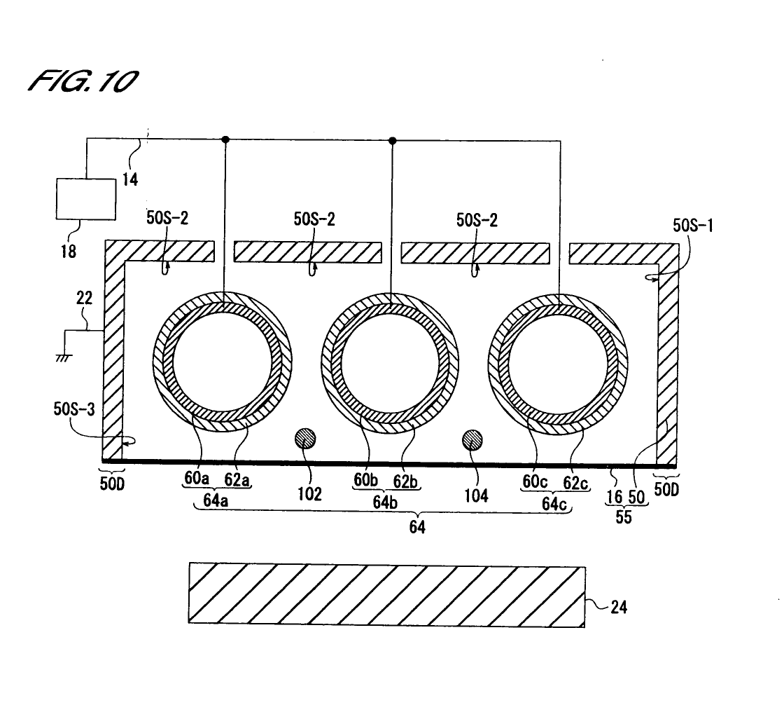

The structure of the fifth dielectric barrier discharge excimer light source in accordance with the present invention will be described below with reference to FIG. 6. FIG. 6 is a schematic transverse cross-sectional view of the fifth dielectric barrier discharge excimer light source in accordance with the present invention, which is perpendicular to the longitudinal direction of the anode. The high-voltage pulse power source 18, lead-in conductive wires 14, 22, and illumination object 24 which are shown in the above-described FIGS. 1 to 5 are herein omitted to avoid making the drawing too complex. The high-voltage pulse power source 18, lead-in conductive wires 14, 22, and illumination object 24 are also omitted in FIG. 7 to FIG. 9 which are referred to for explaining the dielectric barrier discharge excimer light source of Embodiment 6 to Embodiment 8 which are explained hereinbelow.

The fifth dielectric barrier discharge excimer light source differs from the fourth dielectric barrier discharge excimer light source in that the cross-sectional shape of anodes constituting the anode group 70 is rectangular rather than round.

In this structural example, there are provided first, second and third anodes. The first anode 70a has an anode electrode 66a composed of a straight elongated cylindrical body and a dielectric body 68a covering the outer periphery of the anode electrode 66a. The second anode 70b has an anode electrode 66b composed of a straight elongated cylindrical body and a dielectric body 68b, covering the outer periphery of the anode electrode 66b. The third anode 70c has an anode electrode 66c composed of a straight elongated cylindrical body and a dielectric body 68c covering the outer periphery of the anode electrode 66c. Those three anodes 70a, 70b, and 70c are disposed so as to form a row (a row of three in this embodiment) inside a straight long semitubular body 50 along the longitudinal direction of the semitubular body 50. FIG. 5 illustrates a case with three anodes, but the number of anodes is not limited to three, and two or more than three anodes may be arranged.

Further, the anode group 70 and the cathode 50 are disposed parallel to each other in the longitudinal direction and a reflective surface for reflecting the VUV radiation is formed at surfaces (50S-1, 50S-2, and 50S-3) of the cathode 50 at the side opposite the anode group 70.

### Embodiment 6

The structure of the sixth dielectric barrier discharge excimer light source in accordance with the present invention will be described below with reference to FIG. 7. FIG. 7 is a schematic transverse cross-sectional view of the sixth dielectric barrier discharge excimer light source in accordance with the present invention, which is perpendicular to the longitudinal direction of the anode.

The sixth dielectric barrier discharge excimer light source in accordance with the present invention comprises a plurality of discharge electrode units. FIG. 7 shows a dielectric barrier discharge excimer light source composed by providing three discharge electrode units 80, 82, and 84, but the number of discharge electrode units is not limited to three, and two, four or more units may be employed.

The structure of the discharge electrode unit 80 will be explained as an example of the discharge electrode units. The discharge electrode unit 80 comprises an anode electrode 15a and a cathode 25a. The anode 15a comprises an anode electrode 10a in the form of a straight long cylindrical body and a dielectric body 12a covering the outer peripheral surface of the cylindrical body. The cathode 25a has a straight semicylindrical body 20a constituting an elongated cathode portion 20a and a cathode wire group 16a composed of a plurality of wires fixed parallel to each other to this semicylindrical body 20a. The cathode 25a is disposed so as to surround the anode 15a. Further, a reflective surface for reflecting the VUV radiation is formed at a surface 20aS of the cathode portion 20a at the side opposite the anode 15a.

As shown in FIG. 7, the discharge electrode unit 82 and discharge electrode unit 84 of similar configuration are disposed in a row along the longitudinal direction.

### Embodiment 7

The structure of the seventh dielectric barrier discharge excimer light source in accordance with the present invention will be described below with reference to FIG. 8. FIG. 8 is a schematic transverse cross-section view of the seventh dielectric barrier discharge excimer light source in accordance with the present invention, which is perpendicular to the longitudinal direction of the anode.

The seventh dielectric barrier discharge excimer light source in accordance with the present invention comprises a plurality of discharge electrode units. FIG. 8 shows a dielectric barrier discharge excimer light source composed by providing three discharge electrode units 86, 88, and 90, but the number of discharge electrode units is not limited to three, and two, four or more units may be employed.

The structure of the discharge electrode unit 86 will be explained as an example of the discharge electrode units. The discharge electrode unit 86 comprises an anode electrode 15a and a cathode 35a. The anode 15a comprises an anode electrode 10a in the form of a straight long cylindrical body and a dielectric body 12a covering the outer peripheral surface of the cylindrical body. The cathode 35a has a straight semitubular body constituting an elongated cathode portion 30a composed of three surfaces (30S-1, 30S-2, and 30S-3) having an U-shaped cross section perpendicular to the longitudinal direction and a cathode wire group 16a composed of a plurality of wires fixed parallel to each other to this semitubular body. The cathode 35a is disposed so as to surround the anode 15a. Further, a reflective surface for reflecting the VUV radiation is formed at surfaces 30aS-1, 30aS-2, and 30aS-3 of the cathode portion 30a at the side opposite the anode 15a. As shown in FIG. 8, the discharge electrode unit 88 and discharge electrode unit 90 of similar configuration are disposed in a row along the longitudinal direction.

### Embodiment 8

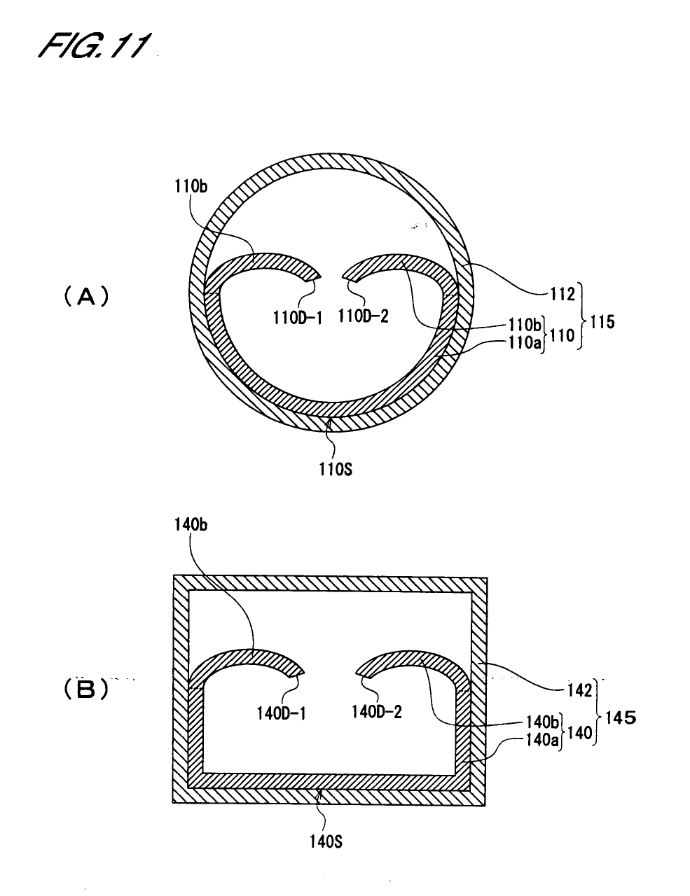

The structure of the eighth dielectric barrier discharge excimer light source in accordance with the present invention will be described below with reference to FIG. 9. FIG. 9 is a schematic transverse cross-sectional view of the eighth dielectric barrier discharge excimer light source in accordance with the present invention, which is perpendicular to the longitudinal direction of the anode.

The eighth dielectric barrier discharge excimer light source in accordance with the present invention comprises a plurality of discharge electrode units. FIG. 9 shows a dielectric barrier discharge excimer light source composed by providing three discharge electrode units 92, 94, and 96, but the number of discharge electrode units is not limited to three, and two, four or more units may be employed.

The structure of the discharge electrode unit 92 will be explained as an example of the discharge electrode units. The discharge electrode unit 92 comprises an anode electrode 45a and a cathode 35a. The anode 45a comprises an anode electrode 40a in the form of a straight long tubular body with a rectangular cross-section and a dielectric body 42a covering the outer peripheral surface of the tubular body. The cathode 35a has a straight semitubular body constituting an elongated cathode portion 30a composed of three surfaces (30S-1, 30S-2, and 30S-3) having an U-shaped cross section perpendicular to the longitudinal direction and a cathode wire group 16a composed of a plurality of wires fixed parallel to each other to this semitubular body. The cathode 35a is disposed so as to surround the anode 45a. Further, a reflective surface for reflecting the VUV radiation is formed at surfaces 30aS-1, 30aS-2, and 30aS-3 of the cathode portion 30a at the side opposite the anode 45a.

As shown in FIG. 9, the discharge electrode unit 94 and discharge electrode unit 96 of similar configuration are disposed in a row along the longitudinal direction.

As described hereinabove, in the dielectric barrier discharge excimer light sources of the Embodiments 4 to 8, anode groups were are composed instead of single anodes. As a result, the total surface area of the dielectric body covering the anode can be expanded by increasing the number of anode units. Therefore, the surface area of possible illumination with respect to the illumination object 24 can be expanded.

### Embodiment 9

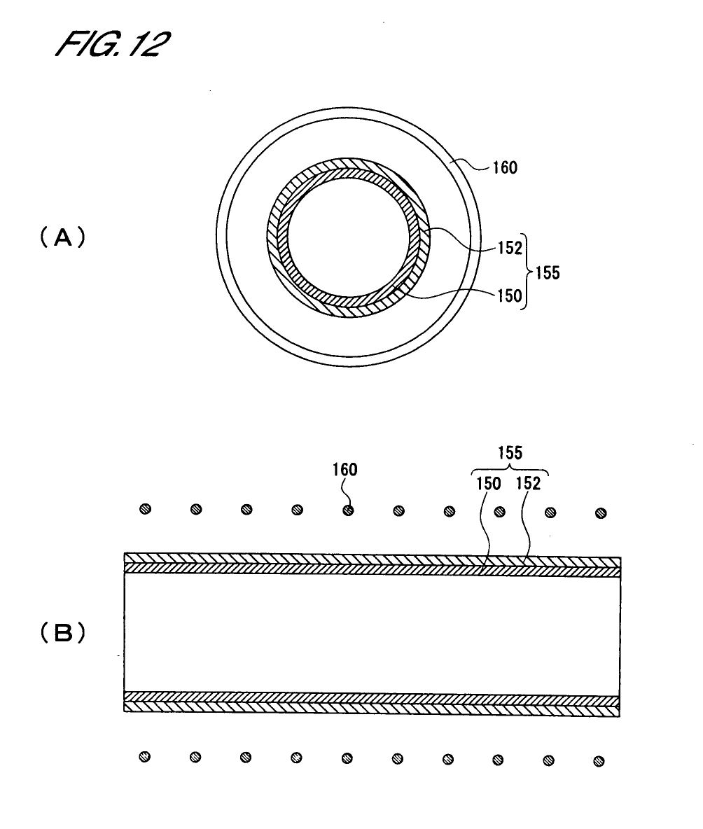

The structure of the ninth dielectric barrier discharge excimer light source in accordance with the present invention will be described below with reference to FIG. 10. The ninth dielectric barrier discharge excimer light source in accordance with the present invention differs from that of the above-described fourth embodiment in that auxiliary rod-like conductors 102 and 104 which are parallel to the longitudinal direction of straight semitubular bodies are disposed in a row on the same plane which is parallel to the cathode wire group 16. The rod-like conductors 102 and 104 are set to the same potential as the cathode.

The rod-like conductor 102 is disposed in the space between the first anode 64a composed of an anode electrode 60a covered with a dielectric body 62a and the second anode 64b composed of an anode electrode 60b covered with a dielectric body 62b, so as to be parallel to those anodes 64a and 64b. Further, it is disposed in a position closer to the plane containing the cathode wire group 16 than to the first and second anodes 64a and 64b, so as to be parallel to the plane containing the cathode wire group 16. Furthermore, the rod-like conductor 104 is disposed in the space between the second anode 64b composed of the anode electrode 60b covered with the dielectric body 62b and the third anode 64c composed of an anode electrode 60c covered with a dielectric body 62c, so as to be parallel to those anodes 64b and 64c. Further, it is disposed in a position close to the plane containing the cathode wire group 16 at an equal distance from the second and third anodes 64b and 64c, so as to be parallel to the plane containing the cathode wire group 16.

The number of anodes in the ninth dielectric barrier discharge excimer light source in accordance with the present invention is not limited to three, as shown in FIG. 10, and may be two or four and more. The number of rod-like conductors that have to be inserted is also increased as the number of anodes increases. Furthermore, a configuration may be also employed in which an anode composed of a straight cylindrical body is used as the aforementioned anode.

Disposing the rod-like conductors in the above-described manner makes it possible to reduce the inductance induced by the lead-in wires 14 or 22 and the wires constituting the cathode wire group 16. The difference between the phase of the voltage applied between the anode and cathode and the phase of the discharge current can be decreased. Therefore, the efficiency of electric power supplied to the dielectric barrier discharge excimer light source can be increased. Thus, a vacuum ultraviolet light source realizing light emission with a high efficiency can be obtained.

### Embodiment 10

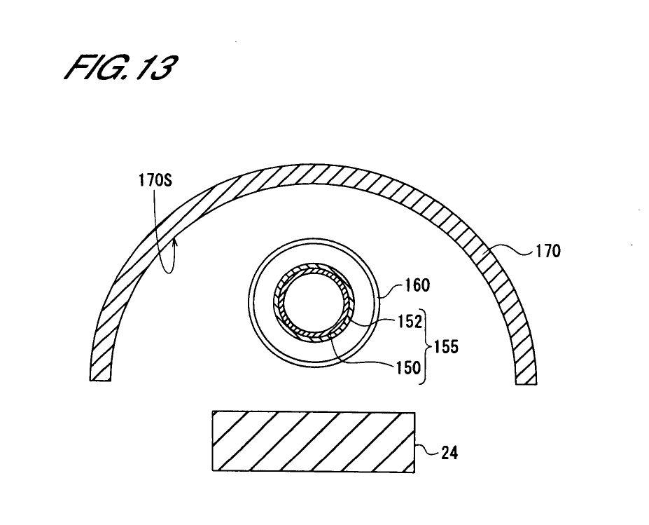

The structure of an anode 115 of the tenth dielectric barrier discharge excimer light source in accordance with the present invention will be described hereinbelow with reference to FIG. 11(A). The anode 115 is composed of an anode electrode 110 and a dielectric body 112 covering the anode electrode. FIG. 11(A) is a schematic transverse cross-sectional view of the anode electrode 110 and the dielectric body 112 covering the anode electrode, this view being obtained by cutting along the plane perpendicular to the longitudinal direction thereof. The anode electrode 110 has a semicylindrical portion 110a and rounded portions 110b which are obtained by rounding from both ends of the semicylindrical portion 110a extending in the longitudinal direction thereof, this rounding being conducted on both sides toward the inside of the semicylindrical portion 110a. The two rounded portions 110b have distal end edges 110D-1 and 110D-2 which are parallel to each other and separated from each other. The convex surface 110S of the semicylindrical portion 110a is disposed in the direction where the cathode wire group is disposed and is provided in contact with the inner surface of the cylindrical dielectric body 112. The transverse cross section of the semicylindrical portion 110a has a semicylindrical shape, and the traverse cross section of the rounded portion 110b may have a curved shape such as to be separated from the inner wall surface of the dielectric body 112.

### Embodiment 11

An anode 145 of the eleventh dielectric barrier discharge excimer light source in accordance with the present invention will be described hereinbelow with reference to FIG. 11(B). The anode 145 is composed of an anode electrode 140 and a dielectric body 142 covering the anode electrode. FIG. 11(B) is a schematic transverse cross-sectional view of the anode electrode 140 and the dielectric body 142 covering the anode electrode, this view being obtained by cutting along the plane perpendicular to the longitudinal direction thereof. The anode electrode 140 has a semirectangular tubular portion 140a and rounded portions 140b which are obtained by rounding from both ends of the semirectangular tubular portion 140a extending in the longitudinal direction thereof, this rounding being conducted on both sides toward the inside of the semirectangular tubular portion 140a. The two rounded portions 140b have distal end edges 140D-1 and 140D-2 which are parallel to each other and separated from each other. The convex surface (bottom surface) 140S of the semirectangular tubular portion 140a is disposed in the direction where the cathode wire group is disposed and is provided in contact with the inner surface of the dielectric body 142 in the form of a rectangular tube. The transverse cross section of the semirectangular tubular portion 140a has a semicylindrical shape, and the transverse cross section of the rounded portion 140b may have a curved shape such as to be separated from the inner wall surface of the dielectric body 142.

Forming the rounded portions 110b and 140b so that they are rounded toward the inside of the semicylindrical portion 110a or toward the inside of the semirectangular tubular portion 140a, as in the anode which is set in the above-described tenth or eleventh dielectric barrier discharge excimer light source, makes it possible to reduce the electrostatic capacitance between the anode electrode 110b of the rounded portion and the dielectric body 112. As a result, the region where plasma is formed can be established exclusively at the side of the convex surface 110S of the semicylindrical portion 110a or bottom surface 140S of the semirectangular tubular portion.

Thus, when of the above-described anode electrode 110 and the dielectric body 112 covering the anode electrode, this anode electrode 110 is rounded toward the inside of the semicylindrical portion, the formation of plasma at the outer side of the dielectric body 112 in the portion where the anode electrode 110 and dielectric body 112 are separated is inhibited. As a result, no light is emitted or the light is emitted but with a reduced brightness. Furthermore, when of the above-described anode electrode 140 and the dielectric body 142 covering the anode electrode, this anode electrode 140 is rounded toward the inside of the semirectangular tubular portion, the formation of plasma at the outer side of the dielectric body 142 in the portion where the anode electrode 140 and dielectric body 142 are separated is inhibited. As a result, no light is emitted or the light is emitted but with a reduced brightness. In other words, the light is mainly emitted at the convex surface 110S of the aforementioned semicylindrical portion or at the bottom surface 140S of the aforementioned semirectangular portion.

Therefore, if the convex surface 110S of the aforementioned semicylindrical portion or the bottom surface 140S of the aforementioned semirectangular portion are so set as to face the side where the sample is disposed, the emission of the vacuum ultraviolet light will be mainly induced in the region at the outer side surface of the dielectric body at the side where the illumination object 24 is disposed (not shown in the figure). Therefore, the illumination object 24 can be illuminated with the VUV with good efficiency.

### Embodiment 12

The twelfth dielectric barrier discharge excimer light source in accordance with the present invention will be described hereinbelow with reference to FIGS. 12(A) and (B). FIG. 12(A) is a schematic transverse cross-sectional view of the dielectric barrier discharge excimer light source obtained by cutting an anode 155 along a plane perpendicular to the longitudinal direction. The anode 155 comprises an anode electrode 150 and a dielectric body 152 covering the anode electrode 150. FIG. 12(B) is a schematic vertical cross-sectional view taken along the longitudinal direction of the anode 155. More particularly, this figure shows the surface exposed after the cut has been made.

The twelfth dielectric barrier discharge excimer light source in accordance with the present invention comprises the anode 155 comprising the anode electrode 150 in the form of a straight elongated cylindrical body and the dielectric body 152 covering the anode electrode 150 and a metallic cathode wire 160 in the form of a spirally shaped body. The thickness of the cathode wire 160 is 2 mm or less, with the maximum value being not more than 2 mm. The spirally shaped body is obtained by spirally winding a wire. The cathode wire 160 is disposed so as to surround the anode 155, the central axis of the cathode wire 160 in the form of a spirally shaped body coinciding with the central axis of the tubular body. The above-described configuration makes it possible to increase the volume of the region occupied by the discharge plasma and to increase accordingly the intensity of the vacuum ultraviolet light which is emitted thereby.

### Embodiment 13

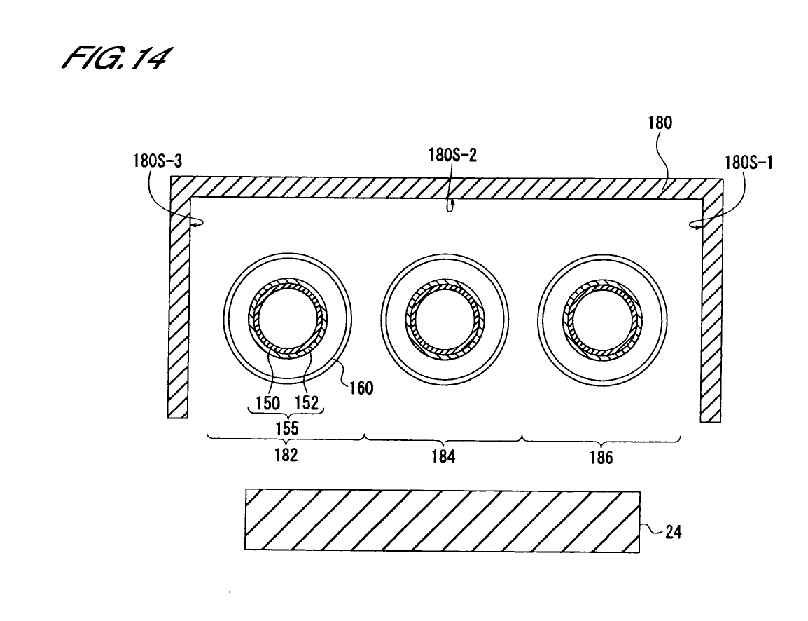

The thirteen dielectric barrier discharge excimer light source in accordance with the present invention will be described hereinbelow with reference to FIG. 13. The difference between the thirteen dielectric barrier discharge excimer light source in accordance with the present invention and the above-described twelfth dielectric barrier discharge excimer light source in accordance with the present invention is that the anode 155 and the cathode wire 160 in the form of a spirally shaped body are disposed inside a reflector 170. The reflector 170 is a straight elongated semicylindrical body. The longitudinal direction of the semicylindrical body, the central axis of the cylindrical body constituting the anode 155, and the central axis of the metallic cathode wire 160 in the form of a spirally shaped body are disposed parallel to each other.

The surface 170S of the reflector 170 which is on the side facing the anode 155 and the metallic cathode wire 160 in the form of a spirally shaped body descends as a surface capable of reflecting the irradiation in the VUV spectral region, that is, the VUV radiation light. As a result, the object which is to be illuminated with the light with a wavelength in a VUV region (illumination object) can be illuminated with good efficiency. The surface 170S can be formed by forming the reflector 170 for example from aluminum which is a material reflecting the irradiation in a VUV spectral region (VUV emitted light) and mirror polishing the surface 170S.

Because the surface 170S has a semicylindrical concave shape, providing the reflector 170 as a new component makes it possible to reflect part of the VUV emitted light which is emitted by the discharge with the surface 170S, and arrange and output the light as an almost parallel beam. As a result, the illumination object 24 can be illuminated with vacuum ultraviolet light to a larger degree.

### Embodiment 14

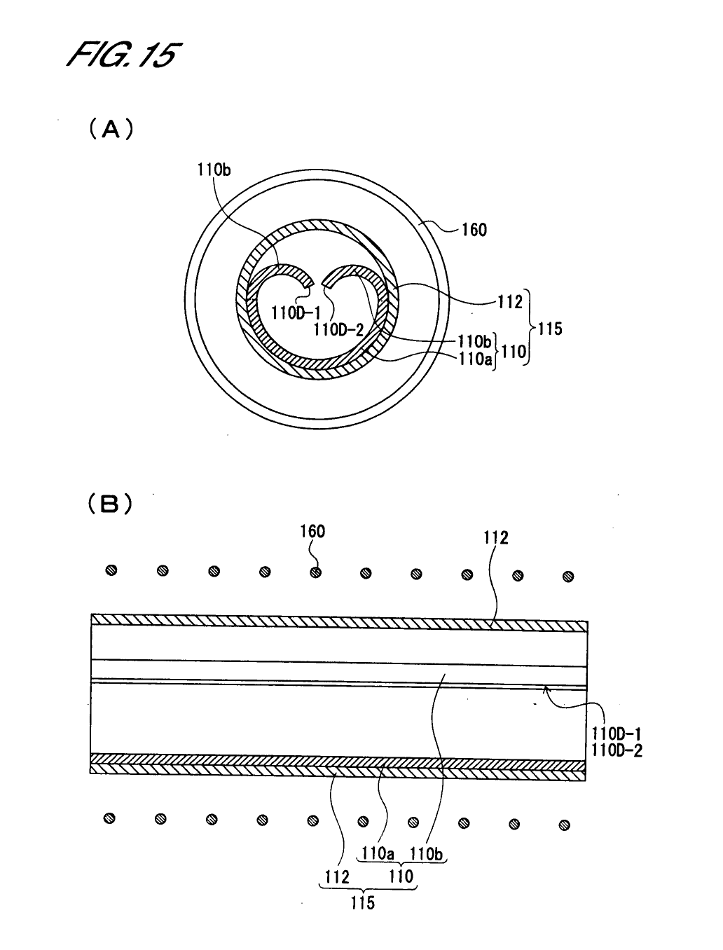

The fourteenth dielectric barrier discharge excimer light source in accordance with the present invention will be described hereinbelow with reference to FIG. 14. A specific feature of the fourteenth dielectric barrier discharge excimer light source in accordance with the present invention is that it is composed by using a plurality of coaxial discharge electrode units 182, 184, 186 each composed of the anode 155 covered with the dielectric body 152 and the cathode wire 160, which were used in the thirteenth dielectric barrier discharge excimer light source. A plurality of coaxial discharge electrode units 182, 184, 186 are disposed in a row so that the central axes thereof are parallel to each other inside one reflector 180.

The reflector 180 is a semirectangular body composed of three surfaces 180S-1, 180S-2, and 180S-3, and having a U-shaped cross section perpendicular to the longitudinal direction, and the central axes of the aforementioned cylindrical bodies are disposed parallel to the longitudinal direction of the semirectangular body. The fourteenth dielectric barrier discharge excimer light source has a configuration comprising a plurality of coaxial discharge electrode units. Therefore, the total surface area of the dielectric body covering the anode can be expanded by increasing the number of anodes. As a result the formation region of the discharge gas plasma, which is the portion from which the light is emitted, can be expanded. As a result, the total emission power is increased and the surface area that can illuminate the illumination object 24 can be enlarged.

### Embodiment 15

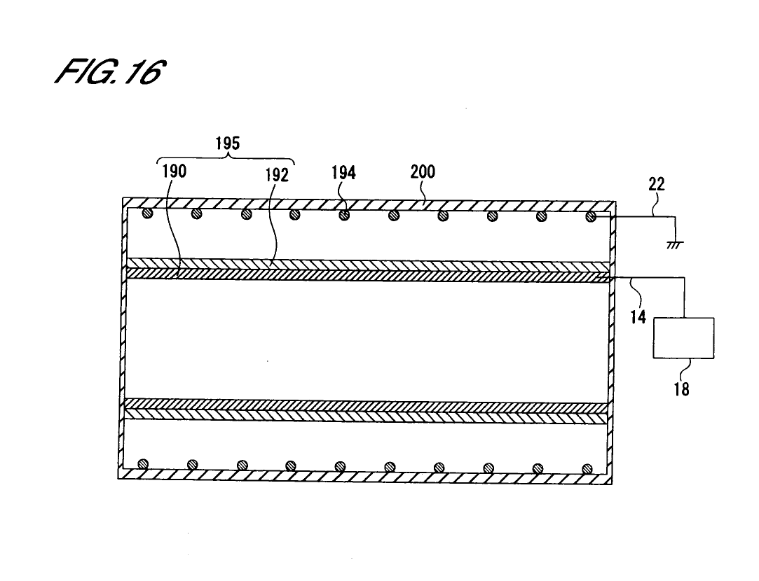

The fifteenth dielectric barrier discharge excimer light source in accordance with the present invention will be described hereinbelow with reference to FIGS. 15(A) and (B). FIG. 15(A) is a schematic transverse cross-sectional view of the fifteenth dielectric barrier discharge excimer light source in accordance with the present invention. FIG. 15(B) is a vertical cross-sectional view showing, in particular, the surface exposed after the cut has been made. Specific features of the structure of the fifteenth dielectric barrier discharge excimer light source in accordance with the present invention are that it comprises the electrode identical to that of the structure of the anode 115 and the dielectric body 112 covering the anode of the tenth dielectric barrier discharge excimer light source and that it comprises the metallic cathode wire 160 in the form of a spirally shaped body of the twelfth dielectric barrier discharge excimer light source. The cathode wire 160 is disposed so as to surround the anode 115, the central axis of the spirally shaped body coinciding with the central axis of the cylindrical body.

With the above-described configuration, similarly to the tenth or eleventh dielectric barrier discharge excimer light source in accordance with the present invention, the region where plasma is formed can be limited to the dielectric body surface at the side of the convex surface 110S of the semicylindrical portion or bottom surface 140S of the semirectangular tubular portion and a light source can be fabricated in which the illumination object 24 can be illuminated with emitted light which is emitted with a higher efficiency.

### Embodiment 16

The sixteenth dielectric barrier discharge excimer light source in accordance with the present invention will be described hereinbelow with reference to FIG. 16. FIG. 16 is a schematic vertical cross-sectional view of the sixteenth dielectric barrier discharge excimer light source in accordance with the present invention showing, in particular, the surface exposed after the cut has been made. The sixteenth dielectric barrier discharge excimer light source in accordance with the present invention comprises a straight elongated anode 195 composed of a cylindrical body, which comprises an anode electrode 190 composed of a straight elongated cylindrical body and a dielectric body 192 covering the anode electrode, and a metallic cathode wire 194 in the form of a spirally shaped body. The cathode wire 194 is disposed so as to surround the anode 195, the central axis of the spirally shaped body coinciding with the central axis of the tubular body. Further, the cathode wire 194 and anode 195 are disposed inside a tube 200 fabricated of a dielectric material which is transparent with respect to the wavelength of the emitted light, and the cathode wire 194 and anode 195 are sealed by the tube 200 fabricated of a dielectric material which is transparent with respect to the wavelength of the emitted light.

Therefore, the illumination object 24 is disposed outside the tube 200 fabricated of a dielectric material and is illuminated with vacuum ultraviolet light. Therefore, the space between the tube 200 and the illumination object 24 has to be filled with a gas that does not absorb the vacuum ultraviolet light, for example, nitrogen, so that no gas absorbing the vacuum ultraviolet light, such as oxygen, be present therein. The illumination object 24 is set in a position above the tube 200 or in a position below the tube 200 shown in FIG. 16.

Further, if fused quarts (for example, fused quartz marketed under a trade name Suprasil) is used as the dielectric material constituting the tube 200, it is transparent with respect to the vacuum ultraviolet light with a wavelength of about 172 nm. Therefore, if Xe gas is a discharge gas that fills the tube 200, because the peak wavelength of the spectrum of light emitted from the excimer molecules is 172 nm, the emitted light in the vacuum ultraviolet region can be picked up outside the tube 200. However, Ar gas or Kr gas (the wavelength of light emission caused by the B-X transition is 126 nm and 146 nm, respectively), which are the inert gases other than Xe, cannot be used as the discharge gas filling the tube 200. This is because fused quartz absorbs light with a wavelength of 160 nm or less.

From the standpoint of light source fabrication, it is advantageous that the cathode wire constituting the above-described twelfth to sixteenth dielectric barrier discharge excimer light sources have a diameter of not more than 2 mm and that the angle formed by the longitudinal direction of the aforementioned straight semicylindrical body or semitubular body and the longitudinal direction of the cathode wires is set to a right angle or to an angle within a range such that an angle shift from the perpendicular position does not exceed 15°.

The above-described first to sixteenth dielectric barrier discharge excimer light sources preferably have a structure which allows a cooling liquid or gas to circulate inside the anode casing. Circulating the cooling liquid or gas inside the anode casing makes it possible to prevent the electrode temperature from rising, to prevent the decrease in the efficiency of plasma formation in the discharge gas by this increase in temperature, and to realize a light source which maintains high efficiency.

In the above-described first to sixteenth dielectric barrier discharge excimer light sources, the cathode structural body, wire (cathode wire group) comprised by the cathode structural body, auxiliary conductors, and cathode wire in the form of a spirally shaped body are preferably manufactured from stainless steel. The anode portion and reflector are preferably manufactured from aluminum. Fused quartz is preferably used for the dielectric body covering the anode electrode.

Further, the thickness of the dielectric body covering the anode electrode is preferably 1.5 mm. The diameter or the length of one side of the rectangle of the perpendicular transverse section of the anode electrode is preferably 23 mm and the length thereof in the longitudinal direction is 200 mm. Further, the diameter or the length of one side of the rectangle of the perpendicular transverse section of the anode electrode may be selected within a range of from 10 mm to 40 mm. Further, the length of the anode electrode in the longitudinal direction may be selected within a range of from 50 mm to 1 m. The diameter of the wires constituting the cathode wire group and the diameter of the auxiliary electrodes is preferably 1 mm.

Further, the diameter of the semicylindrical shape or the length on one side of the U-like shape of the cathode electrode is preferably 80 mm and the length thereof in the longitudinal direction is preferably 200 mm. The diameter of the semicylindrical shape or the length on one side of the U-like shape of the cathode electrode may be selected within a range of from 50 mm to 100 mm. Further, the length of the cathode electrode in the longitudinal direction may be selected within a range of from 50 mm to 1 m.

The high pulse voltage applied between the anode and cathode is preferably 4-6 kV and the frequency thereof is preferably 20 kHz. Further, the frequency may be selected and set within a range of 10-20 kHz. The pressure of the discharge gas is preferably set to 120 Torr (15.96 kPa). It may be selected and set within a range of 80-760 Torr (1.64-101.08 kPa).

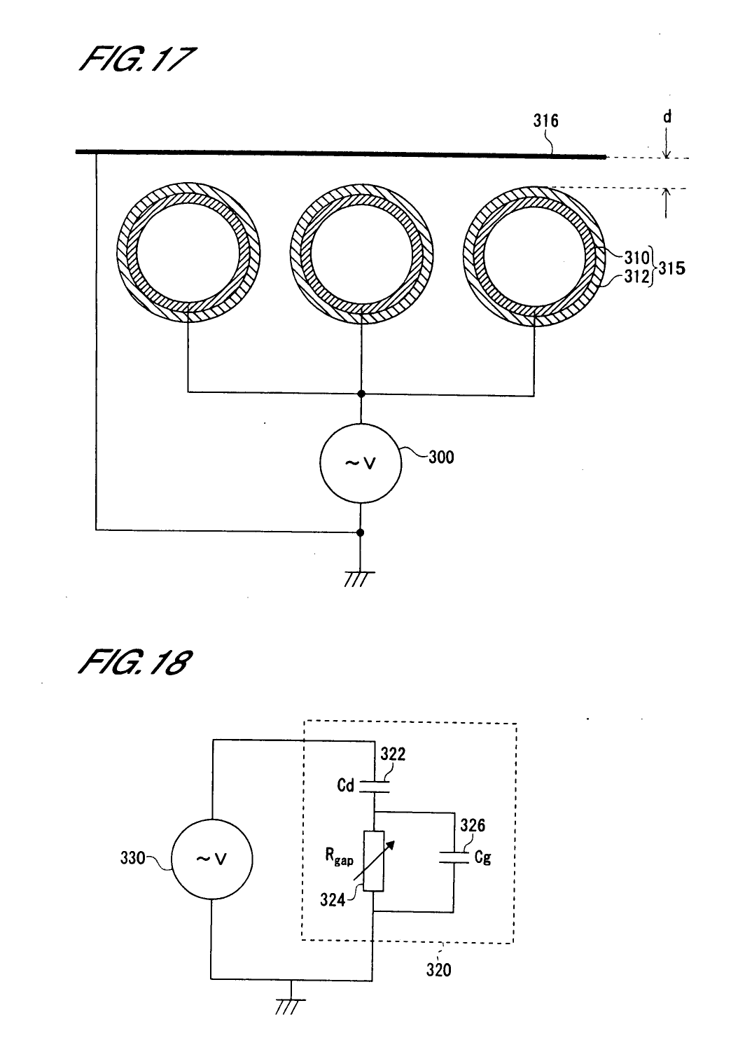

Here, the relationship between the distance between the anode and cathode and the breakdown voltage will be described with reference to FIGS. 17 to 19. The breakdown voltage is the difference in potential between the anode and cathode at the time the discharge is initiated; this definition will be described in greater detail hereinbelow.

FIG. 17 illustrates the mutual arrangement of the anode and cathode. FIG. 17 illustrates schematically the relationship between the electrode configuration and power source of the first to sixteenth dielectric barrier discharge excimer light sources of the present invention and does not represent an electrode structure of the specific embodiment of the present invention. Therefore, FIG. 17 is a figure that should be referred to only when attention is paid to the distance between the anode and cathode by establishing correspondence between the specific electrode structures of the first to sixteenth dielectric barrier discharge excimer light sources of the present invention and the electrode structure shown in FIG. 17. FIG. 17 shows an example of configuration in which three anodes composed of an anode electrode and a dielectric and having identical structures are connected in parallel to the electrode source 300, but the distance between the anode and cathode is also defined as described hereinbelow with respect to a light source with a configuration comprising one anode.

As shown in FIG. 17, an anode 315 composed of an anode electrode 310 and a dielectric body 312 and a cathode wire 316 constituting the cathode are disposed at a distance d from each other. Thus, the distance d between the anode and cathode means the shortest distance between the surface of the dielectric body 312 and the cathode wire 316.

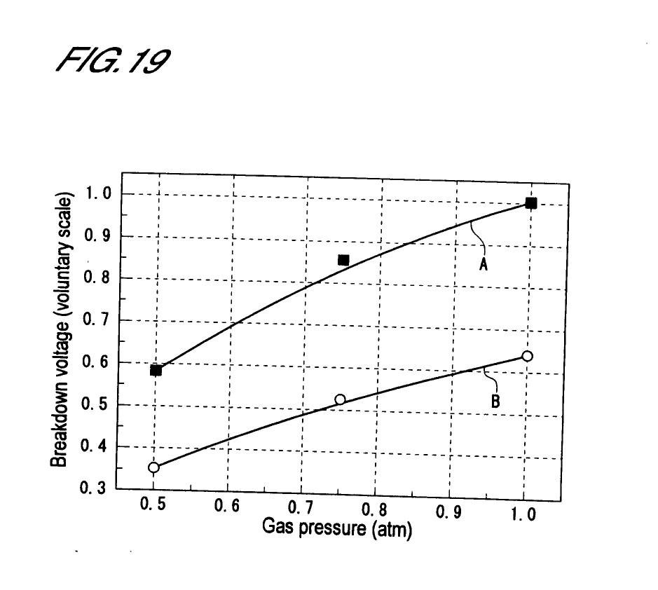

FIG. 18 shows an equivalent circuit comprising a power source and a dielectric barrier discharge excimer light source. FIG. 18 shows a configuration in which a drive power is supplied from the power source 330 to the dielectric barrier discharge excimer light source 320. The capacitance represented by the capacitor 322 with an electrostatic capacitance C_{d} is an electrostatic capacitance of a capacitor with a simulated configuration comprising the dielectric body 312. The electrostatic capacitance caused by the dielectric body 312 will be sometimes represented below simply as the electrostatic capacitance C_{d}. The capacitance represented by the capacitor 326 with an electrostatic capacitance C_{g} is an electrostatic capacitance of a capacitor with a simulated configuration comprising a discharge gas in the space between the anode and cathode. The electrostatic capacitance caused by the discharge gas will be sometimes represented below simply as the electrostatic capacitance C_{g}. Further, the electric resistance represented by a variable resistor 324 with a resistance value R_{gap} is a simulated electric resistance induced by the discharge gas in the space between the anode and cathode. The resistance value of the simulated electric resistor caused by the discharge gas will be sometimes represented below simply as the resistance value R_{gap}.

Referring to FIG. 18, if the dielectric barrier discharge excimer light source 320 is represented by an equivalent circuit, it will be composed of a capacitor with an electrostatic capacitance C_{d}, a capacitor with an electrostatic capacitance C_{g}, and a resistor with a resistance R_{gap}. Thus, in order to discuss the voltage necessary for driving the dielectric barrier discharge excimer light source 320, an electric circuit composed of those capacitors and resistor may be discussed.

An electric discharge is initiated if an electric current flows due to a breakdown of insulating resistor caused by the discharge gas present between the anode and cathode. The breakdown of the insulating resistor is an effect such that if the value of voltage applied to the insulating resistor increases gradually and reaches a certain voltage value, then the resistance R_{gap} thereof naturally decreases. The discharge gas is an insulating substance, but if the voltage applied increases, the insulating ability thereof collapses, the resistance R_{gap} thereof naturally decreases and the electric current flows through the discharge gas, that is, the discharge is initiated. Thus, at this point of time, the dielectric barrier discharge excimer light source starts emitting light. A voltage applied to the resistor at the instant the resistance R_{gap} decreases is called a breakdown voltage.

As follows from the explanation provided above, decreasing the breakdown voltage leads to the reduction of the output voltage required for the high-voltage pulsed power source driving the dielectric barrier discharge excimer light source in accordance with the present invention. Thus, the output voltage of the high-voltage pulsed power source may be equal to or higher than the breakdown voltage. Therefore, if the breakdown voltage decreases, the output voltage of the high-voltage pulsed power source may also decrease accordingly.

FIG. 19 shows the results obtained in studying the breakdown voltage in a dielectric barrier discharge excimer light source that uses Ar as a discharge gas and has an electrode structure shown in FIG. 17. In FIG. 19, the gas pressure is plotted against the abscissa in atmosphere (atm) units, and a breakdown voltage normalized by 1 as a maximum value is plotted against the ordinate. Here, the breakdown voltage shown by 1 on the ordinate is about 2.8-2.9 kV. Therefore, the value at 0.6 corresponds to 1.68-1.74 kV and the value at 0.35 corresponds to 0.98-1.02 kV. Furthermore, the distance d between the anode and cathode was set to d=2 mm and d=5 mm and the breakdown voltage was measured for each of the distances.

The discharge gas pressure was set to 0.5 atm, 0.75 atm, and 1.0 atm, and the breakdown voltage was measured for each pressure. In FIG. 19, the curve A shows the results measured at a setting d=5 mm and the curve B shows the results measured at a setting d=2 mm. According to FIG. 19, the curve B is located below the curve A. Therefore, the smaller is the distance d between the anode and cathode, and lower is the breakdown voltage. This result suggests that the breakdown voltage can be minimized by setting the distance d between the anode and cathode to 0 mm.

As described hereinabove, the dielectric barrier discharge excimer light source can be actuated in a state with a low voltage of the high-voltage pulsed power source supplying power to the light source, if the anode and cathode are disposed in contact with each other.

Furthermore, decreasing the distance d between the anode and cathode localizes plasma close to the surface of the dielectric body 312. Because the dielectric body (quartz glass) covering the cathode is maintained at a low temperature by cooling the cathode with water, the heat generated by plasma can be absorbed with good efficiency. Therefore, the decrease in light emission efficiency caused by the increase in plasma temperature can be prevented and highly efficient light emission can be realized.

The above-described electrode materials and dimensions merely illustrate the preferred examples, and the technological field of the present invention is not limited to the above-described materials or conditions.

### INDUSTRIAL APPLICABILITY

With the above-described first to sixteenth dielectric barrier discharge excimer light sources in accordance with the present invention the illumination object can be effectively illuminated with the emitted light in a vacuum ultraviolet range. Therefore, they are suitable as vacuum ultraviolet light sources suitable for cleaning of material with ultraviolet light or for reforming the material surface with ultraviolet light in the field of microelectronics.

When the present invention is implemented, the invention can employ the following preferred features.

(1) A high-pressure dielectric barrier discharge excimer light source comprising a cathode surrounding an anode equipped with a dielectric cover and having a reduced breakdown voltage for obtaining the radiation in the VUV region of the radiator structure without a pick-out window, wherein at least one side of the cathode is manufactured of a wire with a maximum thickness of no more than 2 mm, the cathode is composed of several wirepiece sets which are arranged in a row perpendicular to the anode axis or at a small angle (no more than 15°) to the direction perpendicular to the anode axis, a monopolar high-voltage pulse is applied to the anode electrode, the cathode is grounded, and the cathode surface portion is used as a reflector to increase the radiation intensity at the physical body which is to be illuminated.

(2) The dielectric barrier discharge excimer light source of clause (1) hereinabove, in which the anode equipped with the dielectric cover is manufactured as a set of several anodes arranged in a row, and the set is enclosed by one cathode.

(3) The dielectric barrier discharge excimer light source of clause (1) hereinabove, in which the cathode and the anode equipped with the dielectric cover are manufactured as a set of several sections arranged in a row close to each other.

(4) The dielectric barrier discharge excimer light source of any clause of clauses (1) to (3) hereinabove, in which the cathode has a right-angular or square cross section.

(5) The dielectric barrier discharge excimer light source of clause (1) or (3) hereinabove, in which the cathode is composed of a half segment.

(6) The dielectric barrier discharge excimer light source of clause (1) or (3) hereinabove, in which the cathode is manufactured as a semicylindrical body having extended edges.

(7) The dielectric barrier discharge excimer light source of clause (1), (2), (3) or (4) hereinabove, in which the anode is set in a dielectric tube with a right-angular or square cross section.

(8) The dielectric barrier discharge excimer light source of clause (1), (2), (3), (4), (5) or (6) hereinabove, in which the anode is set in a cylindrical dielectric tube.

(9) The dielectric barrier discharge excimer light source of clause (1), (2), or (8) hereinabove, in which the cathode comprises additional conductors disposed in the same plate between the dielectric tubes surrounding the anodes.

(10) The dielectric barrier discharge excimer light source of any clause of clauses (1) to (9) hereinabove, in which the anode is manufactured as a half segment having a round edge such that the convex side thereof is oriented in the direction of the cathode wire.

(11) A high-pressure dielectric barrier discharge excimer light source comprising a cathode surrounding an anode equipped with a dielectric cover and having a reduced breakdown voltage for obtaining the radiation in the VUV region of the radiator structure without a extraction window, wherein

the cathode is manufactured of a metallic wire of thickness not more than 2 mm to have a spiral shape, a positive monopolar pulses are applied to the inner electrode of the anode, and the cathode is grounded.

(12) The dielectric barrier discharge excimer light source of clause (11) hereinabove, in which the cathode and anode are disposed in a reflector.

(13) The dielectric barrier discharge excimer light source of any clause of clauses (11) and (12) hereinabove, in which the cathode and anode are composed of several segments arranged in a row and disposed in one reflector.

(14) The dielectric barrier discharge excimer light source of any clause of clauses (11), (12) or (13) hereinabove, in which the anode is produced to have a shape comprising a semicylindrical portion and rounded portion which are obtained by rounding from both ends of the semicylindrical portion in the longitudinal direction thereof, the rounding of each end being conducted in the direction toward the inside of the semicylindrical portion.

(15) The dielectric barrier discharge excimer light source of clause (11) hereinabove, which is designed for ultraviolet, vacuum ultraviolet and visible light region and is manufactured as a light source that requires no sealing and having the cathode inserted in a dielectric tube which is transparent at an operating wavelength.

(16) The dielectric barrier discharge excimer light source of any clause of clauses (1) to (15) hereinabove, in which a cooling liquid or gas is poured into the inner cavity of the anode to cool the dielectric barrier discharge excimer light source.

1. A dielectric barrier discharge excimer light source, comprising:
a discharge electrode unit group having disposed therein discharge electrode units in a row parallel to each other in the longitudinal direction, said discharge electrode unit comprising
an anode having a dielectric body and an anode electrode covered with said dielectric body and composed of a straight elongated hollow cylindrical body, and
an elongated cathode surrounding said anode, said cathode comprising a straight semicylindrical body and a cathode wire group composed of a plurality of wires fixed parallel to each other to said semicylindrical body,
wherein a reflective surface for reflecting the radiation in a vacuum ultraviolet spectral region is formed on the surface of said cathode at the side facing said anode.

2. The dielectric barrier discharge excimer light source according to claim 1,
wherein a plurality of said wires constituting said cathode wire group are stretched between the two ends of said straight semicylindrical body extending along the longitudinal direction thereof;
wherein the diameter of a plurality of said wires constituting said cathode wire group does not exceed 2 nm; and
wherein the angle formed by the longitudinal direction of said straight semicylindrical body and the longitudinal direction of said wires is set to a right angle or to an angle within a range such that an angle shift from the perpendicular position does not exceed 15°.

3. A dielectric barrier discharge excimer light source, comprising:
a discharge electrode unit group having disposed therein discharge electrode units in a row parallel to each other in the longitudinal direction, said discharge electrode unit comprising
an anode having a dielectric body and an anode electrode covered with said dielectric body and composed of a straight elongated hollow cylindrical body, and
an elongated cathode surrounding said anode, said discharge electrode units comprising a straight semitubular body composed of three surfaces and having a U-shaped cross section perpendicular to the longitudinal direction and a cathode wire group composed of a plurality of wires fixed parallel to each other to said semitubular body,
wherein said cathode has formed on the surface of said cathode at the side facing said anode a reflective surface for reflecting the radiation in a vacuum ultraviolet spectral region.

4. The dielectric barrier discharge excimer light source according to claim 3,
wherein a plurality of said wires constituting said cathode wire group are stretched between the two ends of said straight semitubular body extending along the longitudinal direction thereof;
wherein the diameter of a plurality of said wires constituting said cathode wire group does not exceed 2 mm; and
wherein the angle formed by the longitudinal direction of said straight semitubular body and the longitudinal direction of said wires is set to a right angle or to an angle within a range such that an angle shift from the perpendicular position does not exceed 15°.

5. A dielectric barrier discharge excimer light source, comprising:
a discharge electrode unit group having disposed therein discharge electrode units in a row parallel to each other in the longitudinal direction, said discharge electrode unit comprising
an anode having a dielectric body and an anode electrode covered with said dielectric body and composed of an elongated hollow tubular body, said tubular body being composed of four surfaces and having a rectangular cross section perpendicular to the longitudinal direction, and
an elongated cathode surrounding said anode, said cathode comprising a straight semitubular body composed of three surfaces and having a U-shaped cross section perpendicular to the longitudinal direction and a cathode wire group composed of a plurality of wires fixed parallel to each other to said semitubular body,
wherein said cathode has formed on the surface of said cathode at the side facing said anode a reflective surface for reflecting the radiation in a vacuum ultraviolet spectral region.

6. The dielectric barrier discharge excimer light source according to claim 5,
wherein a plurality of said wires constituting said cathode wire group are stretched between the two ends of said straight semitubular body extending along the longitudinal direction thereof;
wherein the diameter of a plurality of said wires constituting said cathode wire group does not exceed 2 mm; and
wherein the angle formed by the longitudinal direction of said straight semitubular body and the longitudinal direction of said wires is set to a right angle or to an angle within a range such that an angle shift from the perpendicular position does not exceed 15°.

7. The dielectric barrier discharge excimer light source according to claim 1, wherein said anode electrode has a semicylindrical shape, the convex surface of said semicylindrical shape being disposed in the direction where said cathode wire group is disposed, and the ends along the longitudinal direction of said semicylindrical shape having the shape rounded toward the inside of said semicylindrical shape.

8. The dielectric barrier discharge excimer light source according to claim 2, wherein said anode electrode has a semicylindrical shape, the convex surface of said semicylindrical shape being disposed in the direction where said cathode wire group is disposed, and the ends along the longitudinal direction of said semicylindrical shape having the shape rounded toward the inside of said semicylindrical shape.

9. The dielectric barrier discharge excimer light source according to claim 3, wherein said anode electrode has a semicylindrical shape, the convex surface of said semicylindrical shape being disposed in the direction where said cathode wire group is disposed, and the ends along the longitudinal direction of said semicylindrical shape having the shape rounded toward the inside of said semicylindrical shape.

10. The dielectric barrier discharge excimer light source according to claim 4, wherein said anode electrode has a semicylindrical shape, the convex surface of said semicylindrical shape being disposed in the direction where said cathode wire group is disposed, and the ends along the longitudinal direction of said semicylindrical shape having the shape rounded toward the inside of said semicylindrical shape.

11. The dielectric barrier discharge excimer light source according to claim 5, wherein said anode electrode has a semitubular rectangular shape, the bottom surface of said semitubular rectangular shape being disposed in the direction where said cathode wire group is disposed, and the ends along the longitudinal direction of said semitubular rectangular shape having the shape rounded toward the inside of said rectangular shape.
